(19) United States
(12) Patent Application Publication
(10) Pub. No.: US 2026/0361876 A1
(43) Pub. Date: Nov. 12, 2026

(54) Inter-frame Contextual Information for Occupancy Coding of Point Clouds

(71) Applicant: Ofinno, LLC, Reston, VA (US)

(72) Inventors: Sébastien Lasserre, Thorigné-Fouillard (FR); Jonathan Taquet, Talensac (FR)

(73) Assignee: Ofinno, LLC, Reston, VA (US)

(21) Appl. No.: 19/730,064

(22) Filed: Jul. 2, 2026

Related U.S. Application Data
(63) Continuation of application No. PCT/US2025/010470, filed on Jan. 6, 2025.
(60) Provisional application No. 63/618,132, filed on Jan. 5, 2024.

(51) Int. Cl. H04N 19/13; H04N 19/169; H04N 19/172; H04N 19/597; H04N 19/91; H04N 19/96

(52) U.S. Cl. CPC H04N 19/13; H04N 19/172; H04N 19/1883; H04N 19/597; H04N 19/91; H04N 19/96

(57) ABSTRACT

A decoder obtains a size of a current volume associated with a current node of an occupancy tree representing a spatial partitioning of a volume encompassing a point cloud frame. An index representing an inter state, of a plurality of inter states, is determined based on comparing a number of points of a motion-compensated point cloud frame belonging in the current volume with at least a threshold dependent on the size of the current volume. An entropy coder is selected based on the index. The decoder entropy decodes, from a bitstream and based on the selected entropy coder, an occupancy bit of an occupancy word of the current node.

### CROSS-REFERENCE TO RELATED APPLICATIONS

This application is a continuation of International Application No. PCT/US2025/010470, filed Jan. 6, 2025, which claims the benefit of U.S. Provisional Application No. 63/618,132, filed Jan. 5, 2024, all of which are hereby incorporated by reference in their entireties.

### BRIEF DESCRIPTION OF THE DRAWINGS

Examples of several of the various embodiments of the present disclosure are described herein with reference to the drawings.

FIG. 1 illustrates an exemplary point cloud coding/decoding system in which embodiments of the present disclosure may be implemented.

FIG. 2 illustrates the Morton order of eight sub-cuboids split from a cuboid.

FIG. 3 illustrates an example processing or scanning order for the first three levels of an occupancy tree.

FIG. 4 illustrates an example of already-coded occupancies of cuboids that may be used to code the occupancy of a current child cuboid.

FIG. 5 illustrates an example of a dynamic reduction function DR that may be used in dynamic OBUF.

FIG. 6 illustrates a flowchart of an example method for coding the occupancy (e.g., as indicated by a single bit) of a current child cuboid using dynamic OBUF.

FIG. 7 illustrates an example of an occupied cube of size N×N×N (where N>1) that corresponds to a TriSoup node of an occupancy tree.

FIG. 8A illustrates an example cube corresponding to a TriSoup node with a number K of TriSoup vertices Vₖ.

FIG. 8B illustrates an example refinement to the TriSoup model by coding a centroid residual vector Cᵣₑₛ into the bitstream such as to use C+Cᵣₑₛ instead of C as pivoting vertex for the triangles.

FIG. 8C illustrates an example of coding a centroid residual vector Cᵣₑₛ in/from the bitstream such that an adjusted centroid C+Cᵣₑₛ is used instead of centroid C for generating TriSoup triangles of a cuboid corresponding to a portion of a point cloud.

FIG. 9A and FIG. 9B illustrate examples of voxelization.

FIG. 10 illustrates an example encoding process based on inter prediction, according to some embodiments.

FIG. 11 illustrates an example decoding process based on inter prediction, according to some embodiments.

FIG. 12A and FIG. 12B illustrate examples of construction of a contextual information, used as input to dynamic OBUF, based on intra-frame prediction information and inter-frame prediction information, according to some embodiments.

FIG. 13A and FIG. 13B illustrate an example of motion estimation error of a motion compensated point cloud geometry, according to some embodiments.

FIG. 14 illustrates an example process for encoding an occupancy bit of an occupancy word of a current node of an occupancy tree based on inter-frame prediction information, according to embodiments.

FIG. 15 illustrates an example process for decoding an occupancy bit of an occupancy word of a current node of an occupancy tree based on inter-frame prediction information, according to embodiments.

FIG. 16 illustrates an example of inter states based on quantized numbers of points of a motion compensated point cloud frame, according to some embodiments.

FIG. 17 illustrates a flowchart of an example method for encoding, in a bitstream, occupancy bits of occupancy words of nodes of an occupancy tree representing a space partitioning of a volume encompassing a point cloud frame, according to some embodiments.

FIG. 18 illustrates a flowchart of an example method for decoding, from a bitstream, occupancy bits of occupancy words of nodes of an occupancy tree representing a space partitioning of a volume encompassing a point cloud frame, according to some embodiments.

FIG. 19 illustrates a block diagram of an example computer system in which embodiments of the present disclosure may be implemented.

### DETAILED DESCRIPTION

In the following description, numerous specific details are set forth in order to provide a thorough understanding of the disclosure. However, it will be apparent to those skilled in the art that the disclosure, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium. A processor(s) may perform the necessary tasks.

Traditional visual data describes an object or scene using a series of points that each comprise a position in two dimensions (x and y) and one or more optional attributes like color. Volumetric visual data adds another positional dimension to this traditional visual data. Volumetric visual data describes an object or scene using a series of points that each comprise a position in three dimensions (x, y, and z) and one or more optional attributes like color, reflectance, time stamp, etc. Compared to traditional visual data, volumetric visual data may provide a more immersive way to experience visual data.

For example, an object or scene described by volumetric visual data may be viewed from any (or multiple) angles, whereas traditional visual data may generally only be viewed from the angle in which it was captured or rendered. Volumetric visual data may be used in many applications, including Augmented Reality (AR), Virtual Reality (VR), and Mixed Reality (MR). Sparse volumetric visual data may be used in the automotive industry for the representation of 3D maps (cartography) or as input to assisted driving systems. In the latter use case, volumetric visual data is typically input to driving decision algorithms. In another example, volumetric visual data may be used to store valuable objects in digital form. In applications for preserving cultural heritage, the goal is to keep a representation of objects that may be threatened by natural disasters. For example, statues, vases, and temples may be entirely scanned and stored as volumetric visual data having several billions of samples. This use case for volumetric visual data may be particularly relevant for valuable objects in locations where earthquakes, tsunamis, and typhoons are frequent. Volumetric visual data may be in the form of a volumetric frame that describes an object or scene captured at a particular time instance or in the form of a sequence of volumetric frames (referred to as a volumetric sequence or volumetric video) that describes an object or scene captured at multiple different time instances.

One format for storing volumetric visual data is point clouds. A point cloud comprises a collection of points in three-dimensional (3D) space. Each point in a point cloud may comprise geometry information that indicates the point's position in 3D space. For example, the geometry information may indicate the point's position in 3D space using three Cartesian coordinates (x, y, and z) or using spherical coordinates (r, phi, theta) (e.g., when acquired by a rotating sensor). The positions of points in a point cloud may be quantized according to a space precision, which may be the same or different in each dimension. The quantization process may create a grid in 3D space. One or more points residing within each sub-grid volume may be mapped to the sub-grid center coordinates, referred to as voxels. A voxel (also referred to as a volumetric pixel) may be considered as a 3D extension of pixels corresponding to the 2D image grid coordinates. For example, similar to a pixel being the smallest unit when dividing the 2D space (or 2D image) into discrete, uniform (e.g., equally sized) regions, a voxel may be the smallest unit of volume when dividing 3D space into discrete, uniform regions. The sub-grid center coordinates (which correspond to voxels) may be referred to as a voxelized grid. A point in a point cloud may further comprise one or more types of attribute information. Attribute information may indicate a property of a point's visual appearance. For example, attribute information may indicate a texture (e.g., color) of the point, a material type of the point, transparency information of the point, reflectance information of the point, a normal vector to a surface of the point, a velocity at the point, an acceleration at the point, a time stamp indicating when the point was captured, or a modality indicating how the point was captured (e.g., running, walking, or flying). In another example, a point in a point cloud may comprise light field data in the form of multiple view-dependent texture information. Light field data may be another type of optional attribute information.

The points in a point cloud may describe an object or a scene. For example, the points in a point cloud may describe the external surface and/or the internal structure of an object or scene. The object or scene may be synthetically generated by a computer or may be generated from the capture of a real-world object or scene. The geometry information of a real-world object or scene may be obtained by 3D scanning and/or photogrammetry. 3D scanning may include laser scanning, structured light scanning, and/or modulated light scanning. 3D scanning may obtain geometry information by moving one or more laser heads, structured light cameras, and/or modulated light cameras relative to an object or scene being scanned. Photogrammetry may obtain geometry information by triangulating the same feature or point in different spatially shifted 2D photographs. Point cloud data may be in the form of a point cloud frame that describes an object or scene captured at a particular time instance or in the form of a sequence of point cloud frames (referred to as a point cloud sequence or point cloud video) that describes an object or scene captured at multiple different time instances.

The data size of a point cloud frame or sequence may be too large for storage and/or transmission in many applications. For example, a single point cloud may comprise over a million points or even billions of points, where each point may comprise geometry information and one or more optional types of attribute information. The geometry information of each point may comprise three Cartesian coordinates (x, y, and z) or spherical coordinates (r, phi, theta) that are each represented, for example, using at least 10 bits per component or 30 bits in total. The attribute information of each point may comprise a texture corresponding to three color components (e.g., R, G, and B color components) that are each represented, for example, using 8-10 bits per component or 24-30 bits in total. A single point therefore comprises at least 54 bits of information in this example, with at least 30 bits of geometry information and at least 24 bits of texture. If a point cloud frame includes a million such points, each point cloud frame would require 54 million bits or 54 megabits to represent. In case of dynamic point clouds that change over time, at a frame rate of 30 frames per second, a data rate of 1.62 gigabits per second would be required to transmit the points of the point cloud sequence. Therefore, raw representations of point clouds may require a large amount of data and the practical deployment of point-cloud-based technologies may need compression technologies that enable the storage and distribution of point clouds with reasonable cost.

Encoding may be used to compress and/or reduce the data size of a point cloud frame or sequence to provide for more efficient storage and/or transmission. Decoding may be used to decompress a compressed point cloud frame or sequence for display and/or other forms of consumption (e.g., by a machine learning-based device, neural network-based device, artificial intelligence-based device, or other forms of consumption by other types of machine-based processing algorithms and/or devices). Compression of point clouds may be lossy (introducing differences relative to the original data) for the distribution to and visualization by an end-user, for example, on AR or VR glasses or any other 3D-capable device. Lossy compression may allow for a high ratio of compression but may imply a trade-off between compression and visual quality perceived by an end-user. Other frameworks, like medical applications or autonomous driving, may require lossless compression to avoid altering the results of a decision obtained based on the analysis of the transmitted and decompressed point cloud frame.

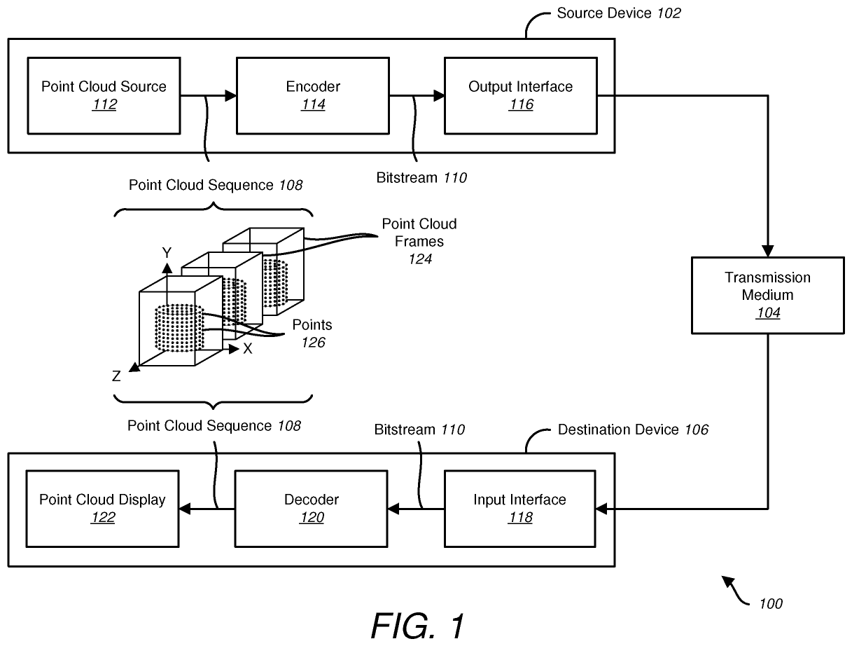

FIG. 1 illustrates an exemplary point cloud coding system 100 in which embodiments of the present disclosure may be implemented. Point cloud coding system 100 comprises a source device 102, a transmission medium 104, and a destination device 106. Source device 102 encodes a point cloud sequence 108 into a bitstream 110 for more efficient storage and/or transmission. Source device 102 may store and/or transmit bitstream 110 to destination device 106 via transmission medium 104. Destination device 106 decodes bitstream 110 to display point cloud sequence 108 or for other forms of consumption. Destination device 106 may receive bitstream 110 from source device 102 via a storage medium or transmission medium 104. Source device 102 and destination device 106 may be any one of a number of different devices, including a cluster of interconnected computer systems acting as a pool of seamless resources (also referred to as a cloud of computers or cloud computer), a server, a desktop computer, a laptop computer, a tablet computer, a smart phone, a wearable device, a television, a camera, a video gaming console, a set-top box, a video streaming device, an autonomous vehicle, or a head mounted display. A head mounted display may allow a user to view a VR, AR, or MR scene and adjust the view of the scene based on movement of the user's head. A head mounted display may be tethered to a processing device (e.g., a server, desktop computer, set-top box, or video gaming console) or may be fully self-contained.

To encode point cloud sequence 108 into bitstream 110, source device 102 may comprise a point cloud source 112, an encoder 114, and an output interface 116. Point cloud source 112 may provide or generate point cloud sequence 108 from a capture of a natural scene and/or a synthetically generated scene. A synthetically generated scene may be a scene comprising computer generated graphics. Point cloud source 112 may comprise one or more point cloud capture devices (e.g., one or more laser scanning devices, structured light scanning devices, modulated light scanning devices, and/or passive scanning devices), a point cloud archive comprising previously captured natural scenes and/or synthetically generated scenes, a point cloud feed interface to receive captured natural scenes and/or synthetically generated scenes from a point cloud content provider, and/or a processor to generate synthetic point cloud scenes.

As shown in FIG. 1, a point cloud sequence 108 may comprise a series of point cloud frames 124. A point cloud frame may describe an object or scene captured at a particular time instance. Point cloud sequence 108 may achieve the impression of motion when a constant or variable time is used to successively present point cloud frames 124 of point cloud sequence 108. A point cloud frame may comprise a collection of points 126 in 3D space. Each of points 126 may comprise geometry information that indicates the point's position in 3D space. For example, the geometry information may indicate the point's position in 3D space using three Cartesian coordinates (x, y, and z). One or more of points 126 may further comprise one or more types of attribute information. Attribute information may indicate a property of a point's visual appearance. For example, attribute information may indicate a texture (e.g., color) of a point, a material type of a point, transparency information of a point, reflectance information of a point, a normal vector to a surface of a point, a velocity at a point, an acceleration at a point, a time stamp indicating when a point was captured, a modality indicating how a point was captured (e.g., running, walking, or flying). In another example, one or more of points 126 may comprise light field data in the form of multiple view-dependent texture information. Light field data may be another type of optional attribute information. Color attribute information of one or more of points 126 may comprise a luminance value and two chrominance values. The luminance value may represent the brightness (or luma component, Y) of the point. The chrominance values may respectively represent the blue and red components of the point (or chroma components, Cb and Cr) separate from the brightness. Other color attribute values are possible based on different color schemes (e.g., an RGB or monochrome color scheme).

Encoder 114 may encode point cloud sequence 108 into bitstream 110. To encode point cloud sequence 108, encoder 114 may apply one or more lossy compression techniques and/or prediction techniques to reduce redundant information in point cloud sequence 108. Redundant information is information that may be predicted at a decoder and therefore may not be needed to be transmitted to the decoder for accurate decoding of point cloud sequence 108. For example, Motion Picture Expert Group (MPEG) introduced a geometry-based point cloud compression (G-PCC) standard (ISO/IEC standard 23090-9: Geometry-based point cloud compression). G-PCC specifies the encoded bitstream syntax and semantics for transmission and/or storage of a compressed point cloud frame and the decoder operation for reconstructing the compressed point cloud frame from the bitstream. During standardization of G-PCC, a reference software (ISO/IEC standard 23090-21: Reference Software for G-PCC) was developed to encode the geometry and attribute information of a point cloud frame. To encode geometry information of a point cloud frame, the G-PCC reference software encoder may perform voxelization by quantizing positions of points in a point cloud, which creates a grid in 3D space. The G-PCC reference software encoder may map the points to the center coordinates of the sub-grid volume (or voxel) that their quantized locations reside. The G-PCC reference software encoder may perform geometry analysis using an occupancy tree to compress the geometry information. The G-PCC reference software encoder may entropy encode the result of the geometry analysis to further compress the geometry information. To encode attribute information of a point cloud, the G-PCC reference software encoder may apply a transform tool, such as Region Adaptive Hierarchical Transform (RAHT), the Predicting Transform, and/or the Lifting Transform. The Lifting Transform may be built on top of the Predicting Transform but with an extra update/lifting step. Consequently, these two transforms may be referred to as Predicting/Lifting Transform or pred lift. Encoder 114 may operate in a same or similar manner to an encoder provided by the G-PCC reference software.

Output interface 116 may be configured to write and/or store bitstream 110 onto transmission medium 104 for transmission to destination device 106. In addition, or alternatively, output interface 116 may be configured to transmit, upload, and/or stream bitstream 110 to destination device 106 via transmission medium 104. Output interface 116 may comprise a wired and/or wireless transmitter configured to transmit, upload, and/or stream bitstream 110 according to one or more proprietary and/or standardized communication protocols, such as Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, 3rd Generation Partnership Project (3GPP) standards, Institute of Electrical and Electronics Engineers (IEEE) standards, Internet Protocol (IP) standards, and Wireless Application Protocol (WAP) standards.

Transmission medium 104 may comprise a wireless, wired, and/or computer readable medium. For example, transmission medium 104 may comprise one or more wires, cables, air interfaces, optical discs, flash memory, and/or magnetic memory. In addition or alternatively, transmission medium 104 may comprise one more networks (e.g., the Internet) or file servers configured to store and/or transmit encoded video data.

To decode bitstream 110 into point cloud sequence 108 for display or other forms of consumption, destination device 106 may comprise an input interface 118, a decoder 120, and a point cloud display 122. Input interface 118 may be configured to read bitstream 110 stored on transmission medium 104 by source device 102. In addition, or alternatively, input interface 118 may be configured to receive, download, and/or stream bitstream 110 from source device 102 via transmission medium 104. Input interface 118 may comprise a wired and/or wireless receiver configured to receive, download, and/or stream bitstream 110 according to one or more proprietary and/or standardized communication protocols, such as those mentioned above.

Decoder 120 may decode point cloud sequence 108 from encoded bitstream 110. For example, decoder 120 may operate in a same or similar manner to a decoder provided by G-PCC reference software. In some examples, decoder 120 may decode a point cloud sequence that approximates point cloud sequence 108 due to, for example, lossy compression of point cloud sequence 108 by encoder 114 and/or errors introduced into encoded bitstream 110 during transmission to destination device 106.

Point cloud display 122 may display point cloud sequence 108 to a user. Point cloud display 122 may comprise a cathode ray tube (CRT) display, a liquid crystal display (LCD), a plasma display, a light emitting diode (LED) display, a 3D display, a holographic display, a head mounted display, or any other display device suitable for displaying point cloud sequence 108.

It should be noted that point cloud coding/decoding system 100 is presented by way of example and not limitation. In the example of FIG. 1, point cloud coding/decoding system 100 may have other components and/or arrangements. For example, point cloud source 112 may be external to source device 102. Similarly, point cloud display 122 may be external to destination device 106 or omitted altogether where point cloud sequence is intended for consumption by a machine and/or storage device. In another example, source device 102 may further comprise a point cloud decoder and destination device 106 may comprise a point cloud encoder. In such an example, source device 102 may be configured to further receive an encoded bit stream from destination device 106 to support two-way point cloud transmission between the devices.

As mentioned above, an encoder may quantize the positions of points in a point cloud according to a space precision, which may be the same or different in each dimension of the points. The quantization process may create a grid in 3D space. The encoder may map any points residing within each sub-grid volume to the sub-grid center coordinates, referred to as a voxel (or a volumetric pixel). A voxel may be considered as a 3D extension of pixels corresponding to 2D image grid coordinates.

The encoder may represent or code the point cloud using an occupancy tree. For example, the encoder may split the initial volume or cuboid (also referred to as a bounding box) containing the point cloud into sub-cuboids. The encoder may then recursively split each sub-cuboid that contains at least one point of the point cloud. The encoder may not further split sub-cuboids that do not contain at least one point of the point cloud. A sub-cuboid that contains at least one point of the point cloud may be referred to as an occupied sub-cuboid. A sub-cuboid that does not contain at least one point of the point cloud may be referred to as an unoccupied sub-cuboid. The encoder may split an occupied cuboid into, for example, two sub-cuboids (to form a binary tree), four sub-cuboids (to form a quadtree), or eight sub-cuboids (to form an octree). The encoder may split an occupied cuboid to obtain sub-cuboids all with the same size and shape at a given depth level of the occupancy tree by splitting following a plane passing through the middle of edges of the cuboid.

The initial volume or cuboid containing the point cloud may correspond to the root node of the occupancy tree. Each occupied sub-cuboid, split from the initial volume/cuboid, may correspond to a node (off the root node) in a second level of the occupancy tree. Each occupied sub-cuboid, split from an occupied sub-cuboid in the second level, may correspond to a node (off the occupied sub-cuboid in the second level from which it was split) in a third level of the occupancy tree. The occupancy tree structure may continue to form in this manner for each recursive split iteration until, for example, a maximum depth level of the occupancy tree is reached or each occupied sub-cuboid has a volume corresponding to one voxel.

Each non-leaf node of the occupancy tree may comprise or be associated with an occupancy word representing an occupancy state of the cuboid corresponding to the node. For example, a node of the occupancy tree corresponding to a cuboid that is split into 8 sub-cuboids may comprise or be associated with a 1-byte occupancy word. Each bit (referred to as an occupancy bit) of the 1-byte occupancy word may represent or indicate the occupancy of a different one of the eight sub-cuboids. Occupied sub-cuboids may be represented or indicated by a binary value of 1 in the 1-byte occupancy word and unoccupied sub-cuboids may be represented or indicated by a binary value of 0 in the 1-byte occupancy word. In other examples, occupied and un-occupied sub-cuboids may be represented or indicated by opposite 1-bit binary values in the 1-byte occupancy word.

Each bit of an occupancy word may represent or indicate the occupancy of a different one of the eight sub-cuboids following the so-called Morton order. For example, the least significant bit of an occupancy word may represent or indicate the occupancy of a first one of the eight sub-cuboids following the Morton order, the second least significant bit of an occupancy word may represent or indicate the occupancy of a second one of the eight sub-cuboids following the Morton order, etc.

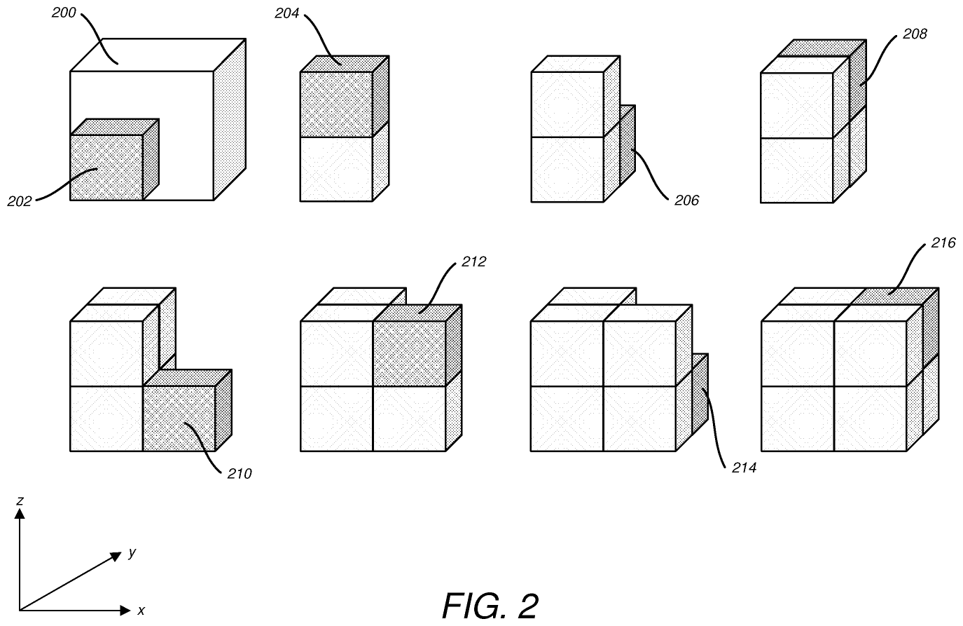

FIG. 2 illustrates the Morton order of eight sub-cuboids 202-216 split from a cuboid 200. Sub-cuboids 202-216 are labeled based on their Morton order, with child node 202 being the first in Morton order and child node 216 being the last in Morton order. The Morton order for sub-cuboids 202-216 is a local lexicographic order in xyz.

The geometry of the point cloud is represented by, and therefore may be determined from, the initial volume and the occupancy words of the nodes in the occupancy tree. The encoder may therefore transmit the initial volume and the occupancy words of the nodes in the occupancy tree in a bitstream to a decoder for reconstructing the point cloud. Before transmitting the initial volume and the occupancy words of the nodes in the occupancy tree, the encoder may entropy encode the occupancy words. For example, the encoder may encode an occupancy bit of an occupancy word of a node corresponding to a cuboid, based on one or more occupancy bits of occupancy words of other nodes corresponding to cuboids that are adjacent or spatially close to the cuboid of the occupancy bit being encoded.

An encoder and/or decoder may code occupancy bits of occupancy words in sequence of a scan order. For example, an encoder and/or decoder may scan an occupancy tree in breadth-first order: all the occupancy words of the nodes of a given depth (or level) within the occupancy tree may be scanned before scanning the occupancy words of the nodes of the next depth (or level). Within a depth, the encoder and/or decoder may scan the occupancy words of nodes in the Morton order. Within a node, the encoder and/or decoder may scan the occupancy bits of the occupancy word of the node further in the Morton order.

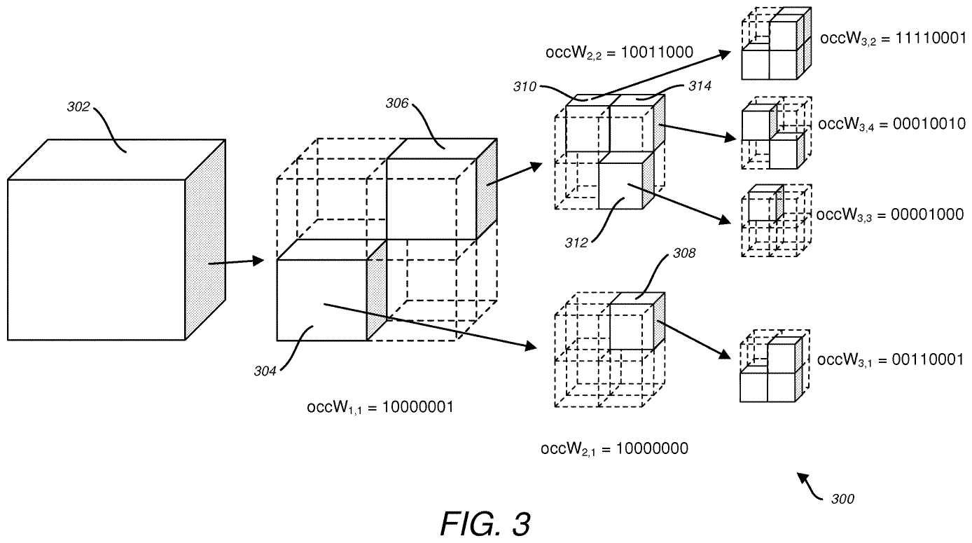

FIG. 3 illustrates an example of this scanning order for the first three levels of an occupancy tree 300. At each level of occupancy tree 300, a plurality of cuboids (e.g., cubes) are generated. In FIG. 3, a cube 302 corresponding to the root node of occupancy tree 300 is divided into eight sub-cubes. Two sub-cubes 304 and 306 of the eight sub-cubes are occupied, while the other six sub-cubes are unoccupied. Following the Morton order, a first eight-bit occupancy word occW_{1,1} is constructed to represent the occupancy word of the root node. The least significant occupancy bit of the first eight-bit occupancy word occW_{1,1} represents or indicates the occupancy of the first sub-cube of the eight sub-cubes in Morton order, the second least significant occupancy bit of the first eight-bit occupancy word occW_{1,1} represents or indicates the occupancy of the second sub-cube of the eight sub-cubes in Morton order, etc.

Each of the two occupied sub-cubes 304 and 306 corresponds to a node off the root node in a second level of occupancy tree 300. The two occupied sub-cubes 304 and 306 are each further split into eight sub-cubes. One of the sub-cubes 308 of the eight sub-cubes split from sub-cube 304 is occupied, while the other seven sub-cubes are unoccupied. Three of the sub-cubes 310, 312, and 314 of the eight sub-cubes split from sub-cube 306 are occupied, while the other five sub-cubes of the eight sub-cubes split from sub-cube 306 are unoccupied. Two second eight-bit occupancy words occW_{2,1} and occW_{2,2} are constructed in this order to respectively represent the occupancy word of the node corresponding to sub-cube 304 and the occupancy word of the node corresponding to sub-cube 306.

Each of the four occupied sub-cubes 308, 310, 312, and 314 corresponds to a node in a third level of occupancy tree 300. The four occupied sub-cubes 308, 310, 312, and 314 are each further split into eight sub-cubes or 32 sub-cubes in total. Four third eight-bit occupancy words occW_{3,1}, occW_{3,2}, occW_{3,3} and occW_{3,4} are constructed in this order to respectively represent the occupancy word of the node corresponding to sub-cube 308, the occupancy word of the node corresponding to sub-cube 310, the occupancy word of the node corresponding to sub-cube 312, and the occupancy word of the node corresponding to sub-cube 314.

Following the scanning order discussed above, the occupancy words of this exemplary occupancy tree 300 may be entropy coded (e.g., entropy encoded by an encoder and entropy decoded by a decoder) as the succession of the seven occupancy words occW_{1,1} to occW_{3,4}. As a consequence of the breadth-first scanning order, when entropy coding the occupancy word of a current child node belonging to a current parent node, the occupancy words of all nodes having the same depth (or level) as the current parent node have already been entropy coded. In addition, the occupancy words of all nodes having the same depth (or level) as the current child node and having a lower Morton order than the current child node have also already been entropy coded. Part of these already coded occupancy words may be used to entropy code the occupancy word of the current child node. For example, the already coded occupancy words of neighboring parent and child nodes may be used to entropy code the occupancy word of the current child node. When entropy coding a particular occupancy bit of the occupancy word of the current child node, the occupancy bits of the occupancy word having a lower Morton order than the particular occupancy bit have also already been entropy coded and may be used to code the occupancy bit of the occupancy word of the current child node.

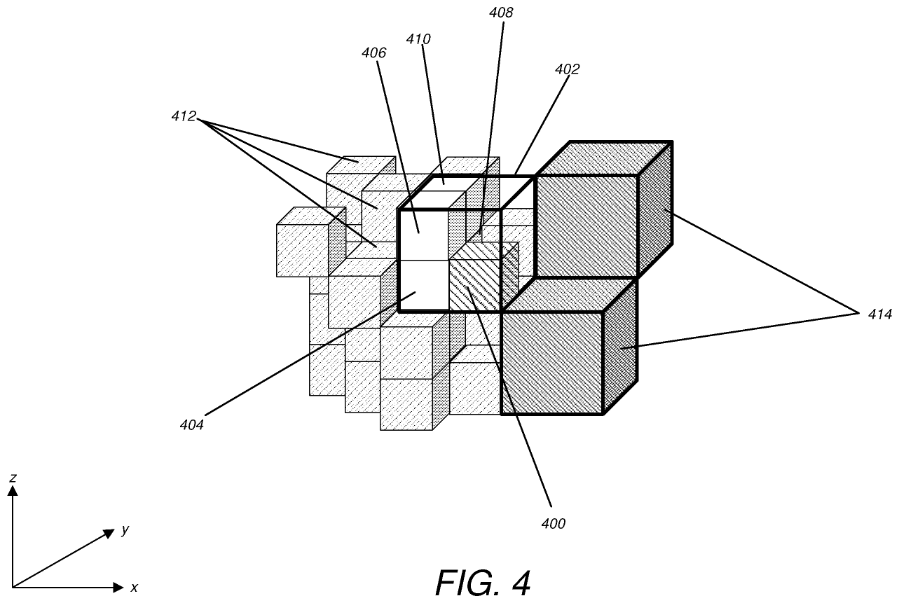

FIG. 4 illustrates an example neighborhood of cuboids with already-coded occupancy bits that may be used to entropy code the occupancy bit of a current child cuboid 400. The neighborhood of cuboids with already-coded occupancy bits may be determined based on the scanning order of an occupancy tree representing the geometry of the cuboids in FIG. 4 as discussed above. As illustrated in FIG. 4, current child cuboid 400 belongs to a current parent cuboid 402. Following the scanning order of the occupancy words and occupancy bits of nodes of the occupancy tree, the occupancy bits of four child cuboids 404, 406, 408, and 410, belonging to the same current parent cuboid 402, have already been coded. Also, the occupancy bit of child cuboids 412 of preceding parent cuboids have already been coded. Furthermore, the occupancy bits of parent cuboids 414, for which the occupancy bits of child cuboids have not already been coded, have already been coded. Therefore, the already-coded occupancy bits of cuboids 404, 406, 408, 410, 412, and 414 may be used to code the occupancy bit of the current child cuboid 400.

The number of possible occupancy configurations for a neighborhood of a current child cuboid may be 2^{N}, where N is the number of cuboids in the neighborhood of the current child cuboid with already-coded occupancy bits. The neighborhood of the current child cuboid may comprise several dozens of cuboids, among them the 26 adjacent parent cuboids sharing a face, an edge, or a vertex with the parent cuboid of the current child cuboid and also several adjacent child cuboids (with occupancy bits already coded) sharing a face, an edge, or a vertex with the current child cuboid. Even limited to a subset of the adjacent cuboids, the occupancy configuration for a neighborhood of the current child cuboid may have billions of possible occupancy configurations making its direct use impractical. The occupancy configuration for a neighborhood of the current child cuboid may be used by an encoder and/or decoder to select the context (or equivalently the probability model), among a set of contexts, of a binary entropy coder (e.g., binary arithmetic coder) that codes the occupancy bit of the current child cuboid. The context-based binary entropy coding may be similar to the Context Adaptive Binary Arithmetic Coder (CABAC) used in MPEG-H Part 2 (also known as High Efficiency Video Coding (HEVC)).

Several methods may be used by an encoder and/or decoder to reduce the occupancy configurations for a neighborhood of a current child cuboid being coded to a practical number of reduced occupancy configurations. Firstly, the 2⁶ or 64 occupancy configurations of the six adjacent parent cuboids sharing a face with the parent cuboid of the current child cuboid may be reduced to 9 occupancy configurations by using geometry invariance. Secondly, an occupancy score for the current child cuboid may be obtained from the 2²⁶ occupancy configurations of the 26 adjacent parent cuboids. The score may be further reduced into a ternary occupancy prediction (“predicted occupied”, “unsure”, “predicted unoccupied”) by applying score thresholds. Thirdly, the number of occupied and the number of unoccupied adjacent child cuboids may be used instead of the individual occupancies of these child cuboids.

An encoder and/or decoder employing one or more of the above methods may reduce the number of possible occupancy configurations for a neighborhood of a current child cuboid to a more manageable number (e.g., a few thousands). However, it has been observed that instead of associating a reduced number of contexts (or probability models) directly to the reduced occupancy configurations, another mechanism may be used, namely Optimal Binary Coders with Update on the Fly (OBUF). An encoder and/or decoder may implement OBUF to limit the number of contexts to a lower number (e.g., 32 contexts).

OBUF may use a limited number (e.g., 32) of contexts that may be fixed. These contexts may be ordered, referred to by a context index (e.g., a context index in the range of 0 to 31), and associated from a lowest virtual probability to a highest virtual probability to code a 1. A Look-Up Table (LUT) of context indices may be initialized at the beginning of a point cloud coding process. For example, the LUT may initially point to a context (e.g., context with context index 15), among the limited number of contexts, with the median virtual probability to code a 1 for all input. This LUT may take an occupancy configuration for a neighborhood of current child cuboid as input and output the context index associated with the occupancy configuration. Consequently, the LUT may have as many entries as reduced occupancy configurations (e.g., around a few thousand). The coding of the occupancy bit of a current child cuboid may follow the steps of determining the reduced occupancy configuration of the current child node, obtaining a context index by applying the reduced occupancy configuration as an entry to the LUT, coding the occupancy bit of the current child cuboid by using the context pointed to (or indicated) by the context index, and finally updating the LUT entry corresponding to the reduced occupancy configuration depending on the value of the coded occupancy bit of the current child cuboid. If a binary 0 (e.g., indicating the current child cuboid is unoccupied) is coded, the LUT entry may be decreased to a lower context index value, and if a binary 1 (e.g., indicating the current child cuboid is occupied) is coded, the LUT entry may be increased to a higher context index value. The update process of the context index may be based on a theoretical model of optimal distribution for virtual probabilities associated with the limited number of contexts. This virtual probability for a context may be fixed by a model and may be different from the internal probability of the context that evolves during the coding of bits of data. The evolution of the internal context may follow a well-known process similar to the process in CABAC.

An encoder and/or decoder may implement a “dynamic OBUF” scheme that may handle a much larger number of occupancy configurations for a neighborhood of a current child cuboid than can be handled by general OBUF, while maintaining complexity within reasonable bounds. The use of a larger number of occupancy configurations for a neighborhood of a current child cuboid may lead to improved compression capabilities. By using an occupancy tree compressed by OBUF, an encoder and/or decoder may reach a lossless compression performance as good as 1 bit per point (bpp) for coding the geometry of dense point clouds. An encoder and/or decoder may implement dynamic OBUF to potentially further reduce the bitrate by more than 25% to 0.7 bpp.

OBUF may not take as input a large variety of reduced occupancy configurations for a neighborhood of a current child cuboid, thus potentially leading to a loss of useful correlation. The size of the LUT of context indices may be increased to handle more various occupancy configurations for a neighborhood of a current child cuboid as input. However, by doing so, statistics may be diluted, and compression performance may be reduced. For example, if the LUT has millions of entries and the point cloud has a hundred thousand points, then most of the entries are never visited. Worse yet, many entries may be visited only a few times and their associated context indices may not be updated enough times to reflect any meaningful correlation between the occupancy configuration value and the probability of occupancy of the current child cuboid. Dynamic OBUF may be implemented to mitigate the dilution of statistics due to the increase in the number of occupancy configurations for a neighborhood of a current child cuboid. This mitigation is performed by a “dynamic reduction” of occupancy configurations in dynamic OBUF.

Dynamic OBUF may add an extra step of reduction of occupancy configurations for a neighborhood of a current child cuboid before applying the LUT of context indices. This step may be called a dynamic reduction because it evolves based on the progress of the coding of the point cloud or, more precisely, based on already visited occupancy configurations.

As discussed above, many possible occupancy configurations for a neighborhood of a current child cuboid are potentially involved but only a subset may be visited during the coding of a point cloud. This subset may characterize the type of the point cloud. For example, when coding AR or VR dense point clouds, most of the visited occupancy configurations may exhibit occupied adjacent cuboids of a current child cuboid. On the other hand, when coding sensor-acquired sparse point clouds, most of the visited occupancy configurations may exhibit only a few occupied adjacent cuboids of a current child cuboid. The role of the dynamic reduction may be to obtain a more precise correlation based on the most visited occupancy configuration while putting aside (or reducing aggressively) other occupancy configurations that are much less visited. The dynamic reduction may be updated on-the-fly, as detailed below, after each visit of an occupancy configuration during the coding of occupancy data.

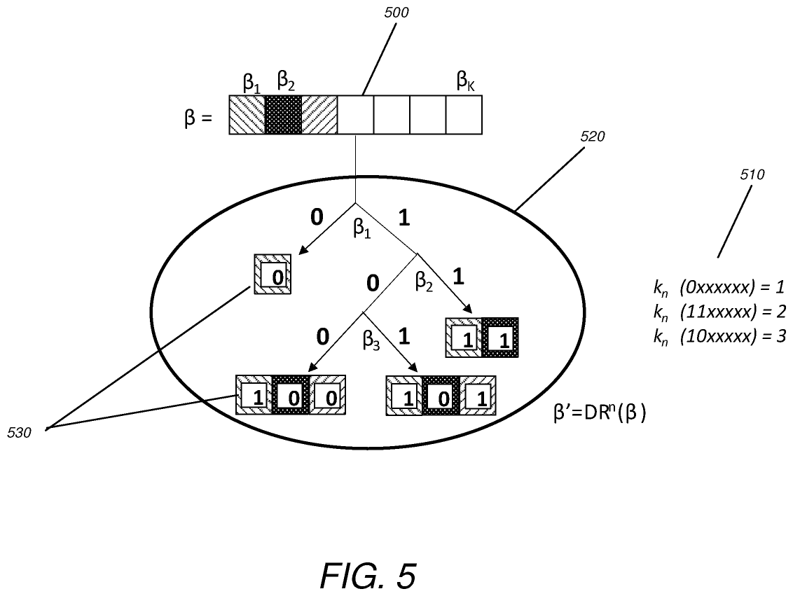

FIG. 5 illustrates an example of a dynamic reduction function DR that may be used in dynamic OBUF. The dynamic reduction function DR may be obtained by masking bits βⱼ of occupancy configurations 500:

β=β₁ . . . β_{K}

made of K bits. The size of the mask may decrease when occupancy configurations are visited a certain number of times. The initial dynamic reduction function DR⁰ may mask all bits for all occupancy configurations such that it is a constant function DR⁰(β)=0 for all occupancy configurations β. After each coding of an occupancy bit, the dynamic reduction function may evolve from a function DRⁿ to an updated function DRⁿ⁺¹. The function may be defined by:

β′=DRⁿ(β)=β₁ . . . β_{kn(β)}

where kₙ(β) 510 is the number of non-masked bits. The initialization of DR⁰ may correspond to k₀(β)=0, and the natural evolution of the reduction function towards finer statistics may lead to an increasing number of non-masked bits kₙ(β)≤kₙ₊₁(β). The dynamic reduction function may be entirely determined by the values of kₙ for all occupancy configurations β.

The visits to occupancy configurations may be tracked by a variable NV(β′) for all dynamically reduced occupancy configurations β′=DRⁿ(β). After the coding of an occupancy bit based on an occupancy configuration β^{V}, the corresponding number of visits NV(β^{V}′) may be increased by one. If this number of visits NV(β^{V}′) is greater than a threshold th_{V},

NV(β^{V}′)>Th_{V}

then the number of unmasked bits kₙ(β) may be increased by one for all occupancy configurations β being dynamically reduced to β^{V}′. Practically, this corresponds to replacing the dynamically reduced occupancy configuration β^{V}′ by the two new dynamically reduced occupancy configurations β⁰′ and β¹′ defined by

β⁰′=β^{V}_{′0}=β^{V}₁ . . . β^{V}_{kn(β)}0 and β¹′=β^{V}_{′1}=β^{V}₁ . . . β^{V} _{kn(β)}1.

In other words, the number of unmasked bits has been increased by one kₙ₊₁(β)=kₙ(β)+1 for all occupancy configurations β such that DRⁿ(β)=β^{V}′. The number of visits of the two new dynamically reduced occupancy configurations may then be initialized to zero:

NV(β⁰′)=NV(β¹′)=0. (I)

At the start of the coding, the initial number of visits for the initial dynamic reduction function DR⁰ may be set to

NV(DR⁰(β))=NV(0)=0,

and the evolution of NV on dynamically reduced occupancy configurations may now be entirely defined.

When a dynamically reduced occupancy configuration β^{V}′ is replaced by the two new dynamically reduced occupancy configurations β⁰′ and β¹′, the corresponding LUT entry LUT[β^{V}′] may be replaced by the two new entries LUT[β⁰′] and LUT[β¹′] that are initialized by the context index associated with β^{V}′,

LUT[β⁰′]=LUT[β¹′]=LUT[β^{V}′], (II)

and then evolve separately. The evolution of the LUT of context indices on dynamically reduced occupancy configurations may thus be entirely defined.

The reduction function DRⁿ may be modeled by a series of growing binary trees Tⁿ 520 whose leaf nodes 530 are the reduced occupancy configurations β′=DRⁿ(β). The initial tree may be the single root node associated with 0=DR⁰(β). The replacement of the dynamically reduced to β^{V}′ by β⁰′ and β¹′ corresponds to growing the tree Tⁿ from the leaf node associated with β^{V}′ by attaching to it two new nodes associated with β⁰′ and β¹′. The tree Tⁿ⁺¹ may be obtained by this growth. The number of visits NV and the LUT of context indices may be defined on the leaf nodes and evolve with the growth of the tree through equations (I) and (II).

In some examples, dynamic OBUF may be practically implemented by storage of the array NV[β′] and the LUT[β′] of context indices, as well as the trees Tⁿ 520. An alternative to the storage of the trees may be to store the array kₙ[β] 510 of the number of non-masked bits.

A limitation for implementing dynamic OBUF may be its memory footprint. In some applications, a few million occupancy configurations may be practically handled, leading to about 20 bits βᵢ constituting an entry configuration β to the reduction function DR. Each bit βᵢ may correspond to the occupancy status of a neighboring cuboid of a current child cuboid or a set of neighboring cuboids of a current child cuboid.

Higher bits βᵢ (e.g., β₀, β₁, etc.) may be the first bits to be unmasked during the evolution of the dynamic reduction function DR. Therefore, the order of neighbor-based information put in the bits βᵢ may impact the compression performance. In some examples, neighboring information may be ordered from highest priority to lower priority and put in this order into the bits βᵢ, from higher to lower weight. For example, the priority may be, from the most important to the least important, occupancy of sets of adjacent neighboring child cuboids, then occupancy of adjacent neighboring child cuboids, then occupancy of adjacent neighboring parent cuboids, then occupancy of non-adjacent neighboring child nodes, and finally occupancy of non-adjacent neighboring parent nodes. Adjacent nodes sharing a face with the current child node may also have higher priority than adjacent nodes sharing an edge or, worse, only a vertex with the current child node.

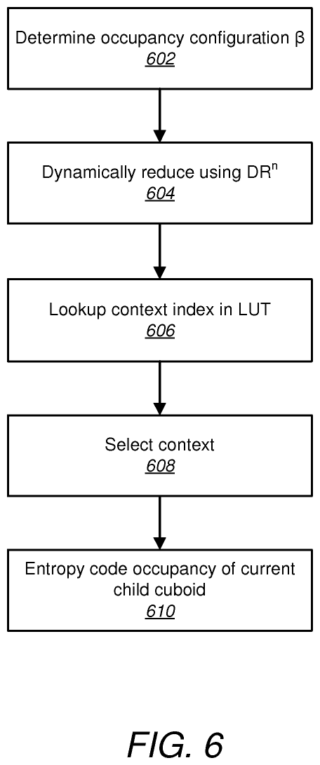

FIG. 6 illustrates a flowchart of an exemplary method for coding the occupancy bit of a current child cuboid using dynamic OBUF. The method of the flowchart begins at block 602. At block 602, an encoder and/or decoder may determine the occupancy configuration β of already-coded cuboids in a neighborhood of the current child cuboid. At block 604, the encoder and/or decoder may dynamically reduce the occupancy configuration β into a reduced occupancy configuration β′=DRⁿ(β). At block 606, the encoder and/or decoder may lookup context index LUT[β′] in the LUT of the dynamic OBUF. At block 608, the encoder and/or decoder may select the context (or probability model) pointed to by the context index. At block 610, the encoder and/or decoder may entropy code (e.g., arithmetic code) the occupancy bit of the current child cuboid based on the context. Thus, the occupancy bit of the current child cuboid may be coded based on occupancy bits of the already-coded cuboids neighboring the current child cuboid.

Although not shown in FIG. 6, the encoder and/or decoder may further update the reduction function DRⁿ into DRⁿ⁺¹ and update the context index LUT[β′] based on the occupancy bit of the current child cuboid. In addition, the method of FIG. 6 may be repeated for additional or all child cuboids of parent cuboids corresponding to nodes of the occupancy tree in a scan order, such as the scan order discussed above with respect to FIG. 3.

In general, the occupancy tree is a lossless compression technique. The occupancy tree may be adapted to provide lossy compression by modifying the point cloud on the encoder side (e.g., down-sampling, removing points, moving points, etc.) but the lossy compression performance may be reduced/weak. However, the use of the occupancy tree as a lossless compression technique may be very useful for dense point clouds.

One approach to lossy compression for point cloud geometry may be to set the maximum depth of the occupancy tree to not reach the smallest volume size of one voxel but instead to stop at a bigger volume size (e.g., N×N×N cubes, where N>1). The geometry of the points belonging to each occupied leaf node associated with the bigger volumes may then be modeled. This approach may be particularly suited for dense and smooth point clouds that may be locally modeled by smooth functions like planes or polynomials. The coding cost may become the cost of the occupancy tree plus the cost of the local model in each of the occupied leaf nodes.

A scheme for modeling the geometry of the points belonging to each occupied leaf node, associated with a volume size larger than one voxel, may use sets of triangles as local models. This scheme may be referred to as the “TriSoup” scheme. TriSoup is short for “Triangle Soup” because the connectivity between triangles may not be part of the models. An occupied leaf node, of an occupancy tree, that corresponds to a cuboid with a volume greater than one voxel may be referred to as a TriSoup node. An edge belonging to at least one cuboid corresponding to a TriSoup node may be referred to as a TriSoup edge. A TriSoup node may comprise a presence flag (sₖ) for each TriSoup edge of its corresponding occupied cuboid. A presence flag (sₖ) of a TriSoup edge may indicate (a presence of or) whether a TriSoup vertex (Vₖ) is present or not on the TriSoup edge. At most one TriSoup vertex (Vₖ) may be present on a TriSoup edge. For each vertex (Vₖ) present on a TriSoup edge of an occupied cuboid, the TriSoup node corresponding to the occupied cuboid may further comprise a position (pₖ) of the vertex (Vₖ) along the TriSoup edge.

In addition to the occupancy words of an occupancy tree, an encoder may entropy encode, for each TriSoup node of the occupancy tree, a TriSoup vertex presence flag (and a position of a TriSoup vertex, if present, along a TriSoup edge) of each TriSoup edge belonging to the TriSoup node. A decoder may similarly entropy decode the TriSoup vertex presence flags and positions of each TriSoup vertex along a respective TriSoup edge belonging to a TriSoup node of the occupancy tree, in addition to the occupancy words of the occupancy tree.

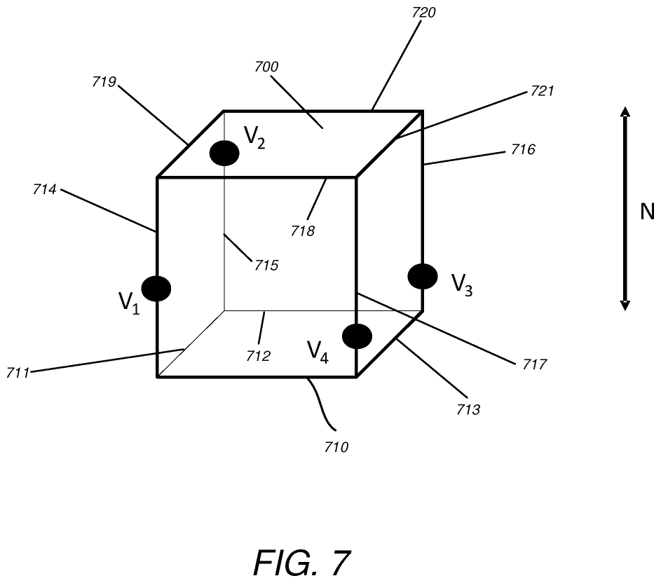

FIG. 7 illustrates an example of an occupied cube 700 of size N×N×N (where N>1) that corresponds to a TriSoup node of an occupancy tree. Occupied cube 700 comprises TriSoup edges 710-721. The TriSoup node, corresponding to occupied cube 700, comprises a presence flag (sₖ) for each TriSoup edge of TriSoup edges 710-721. The presence flag of TriSoup edge 714 indicates that a TriSoup vertex V₁ is present on TriSoup edge 714. The presence flag of TriSoup edge 715 indicates that a TriSoup vertex V₂ is present on TriSoup edge 715. The presence flag of TriSoup edge 716 indicates that a TriSoup vertex V₃ is present on TriSoup edge 716. The presence flag of TriSoup edge 717 indicates that a TriSoup vertex V₄ is present on TriSoup edge 717. The presence flags of the remaining TriSoup edges each indicates that a TriSoup vertex is not present on their corresponding TriSoup edge. The TriSoup node, corresponding to occupied cube 700, further comprises a position (pₖ) for each TriSoup Vertex present along one of its TriSoup edges 710-721. More specifically, the TriSoup node (corresponding to occupied cube 700) further comprises a position p₁ for TriSoup vertex V₁, a position p₂ for TriSoup vertex V₂, a position p₃ for TriSoup vertex V₃, and a position p₄ for TriSoup vertex V₄. The TriSoup vertices may be shared among TriSoup nodes along TriSoup edge(s) in common.

In some examples, a presence flag (sₖ) and, if the presence flag (sₖ) indicates the presence of a vertex, a position (pₖ) (the presence flag (sₖ) and position (pₖ) individually or collectively referred to as vertex information) of the vertex along a current TriSoup edge may be entropy coded based on already-coded presence flags and positions (of present TriSoup vertices) of TriSoup edges that neighbor the current TriSoup edge. A presence flag (sₖ) and, if the presence flag (sₖ) indicates the presence of a vertex, a position (pk) on (e.g., indicating a position of the vertex along) a current TriSoup edge may be additionally or alternatively entropy coded based on occupancies of cuboids that neighbor the current TriSoup edge. Similar to the entropy coding of the occupancy bits of the occupancy tree, a configuration βTS for a neighborhood (also referred to as a neighborhood configuration βTS) of a current TriSoup edge may be obtained and dynamically reduced into a reduced configuration βTS′=DRn(βTS) by using a dynamic OBUF scheme for TriSoup. A context index LUT[βTS′] may be obtained from the OBUF LUT and at least a part of the vertex information of the current TriSoup edge may be entropy coded using the context (or probability model) pointed to by the context index.

In order to use a binary entropy coder to entropy code at least part of the vertex information of the current TriSoup edge, the TriSoup vertex position (pₖ) (if present) along its TriSoup edge may be binarized. A number of bits N_{b} may be set for the quantization of the TriSoup vertex position (pₖ) along the TriSoup edge of length N that is uniformly divided into 2^{Nb} quantization intervals. By doing so, the TriSoup vertex position (pₖ) may be represented by N_{b} bits (pₖⱼ, j=1, . . ., Nb) that may be individually coded by the dynamic OBUF scheme as well as the bit corresponding to the presence flag (sₖ). The neighborhood configuration βTS, the OBUF reduction function DRn, and thus the context index may depend on the nature/characteristic/property of the coded bit (presence flag (sₖ), highest position bit (pₖ₁), second highest position bit (pₖ₂), etc.). Therefore, there may be several dynamic OBUF schemes implemented, with each dedicated to a specific bit of information (presence flag (sₖ) or position bit (pₖ ^{j})) of the vertex information.

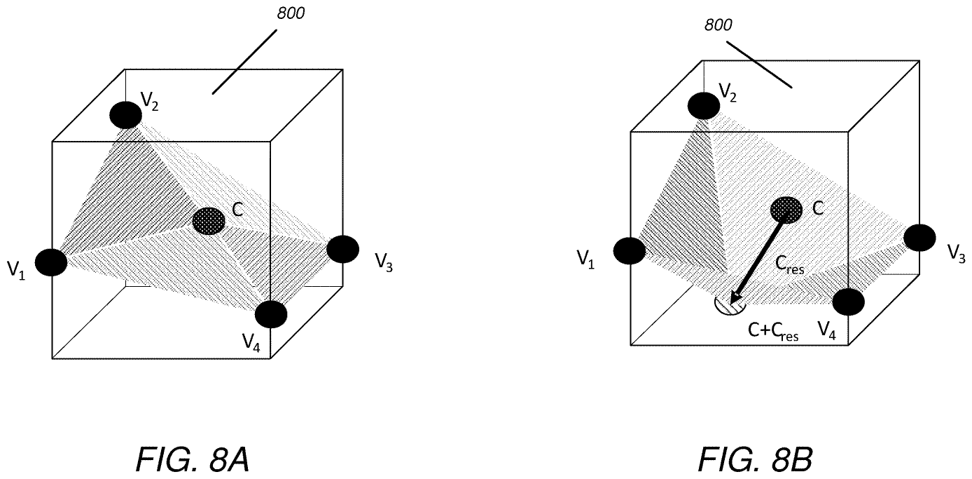

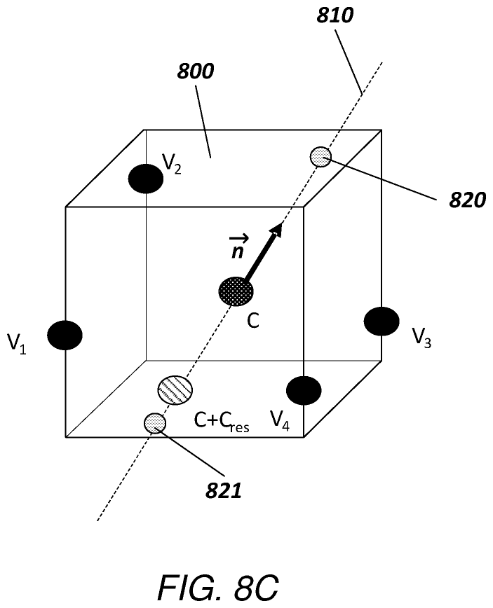

FIG. 8A illustrates a cuboid 800 (e.g., a cube) corresponding to a TriSoup node with a number K of TriSoup vertices Vₖ. Within cuboid 800, TriSoup triangles may be constructed from the TriSoup vertices Vₖ if at least three (K≥3) TriSoup vertices are present on the TriSoup edges of cuboid 800. In the example of FIGS. 8A, 4 TriSoup vertices are present and therefore TriSoup triangles are constructed. The TriSoup triangles may be constructed around the centroid vertex C defined as the mean of the TriSoup vertices Vₖ. In some examples, to construct the TriSoup triangles, a dominant direction may first be determined, then vertices Vₖ may be ordered by turning around this direction, and finally the following K TriSoup triangles (listed as triples of vertices) are constructed: V₁V₂C, V₂V₃C, . . . , V_{K}V₁C. The dominant direction may be chosen among the three directions parallel to the axis of the 3D space to increase or maximize the 2D surface of the triangles when projected along the dominant direction. By doing so, the dominant direction may be somewhat perpendicular to a local surface defined by the points of the point cloud belonging to the TriSoup node.

FIG. 8B illustrates a refinement to the TriSoup model by coding a centroid residual vector Cᵣₑₛ into the bitstream such as to use C+Cᵣₑₛ instead of C as a pivoting vertex for constructing/generating the triangles. By doing so, the vertex C+Cᵣₑₛ may be closer to the points of the point cloud than the centroid C used to model the points, which reduces the reconstruction error and leads to lower distortion at the cost of a small increase in bitrate needed for coding Cᵣₑₛ.

FIG. 8C illustrates a more detailed example of coding a centroid residual vector Cᵣₑₛ in/from the bitstream such that an adjusted centroid C+Cᵣₑₛ is used instead of centroid C for generating TriSoup triangles of a cuboid 800 (corresponding to a TriSoup node) corresponding to a portion of a point cloud, according to some embodiments. For example, the triangles may be generated based on adjusted centroid C+Cᵣₑₛ and adjacent pairs of vertices of an ordering of the vertices V₁-V₄, determined as described above with respect to FIG. 8A. Further, as described above, the TriSoup triangles of the cuboid may be voxelized at the decoder to generate voxels representing (or modeling) the portion, of the point cloud, corresponding to the cuboid. A unit vector \vec{n} (i.e., also referred to as a normalized vector) may be determined as a normalized mean vector of normal vectors to the triangles (V₁V₂C, V₂V₃C, . . . , V_{K}V₁C) constructed by centroid C and pairs of the vertices of the cuboid by pivoting around the centroid C (e.g., as described in FIG. 8A). For example, the unit vector \vec{n} may be determined as the normalized vector based on a mean of cross-products representing areas of the triangles (\vec{V₁C}×\vec{V₂C}+\vec{V₂C}×\vec{V₃C}+ . . . +\vec{V_{K}C}×\vec{V₁C})/K. For example, the unit vector \vec{n} may be determined by dividing the mean vector (n) by the norm (or length) of the mean vector (i.e., \vec{n}=n/||n||).

A value resulting from each cross product is equal to an area of a parallelogram formed by the two vectors in the cross product. Therefore, the value may be representative of an area of a triangle formed by the two vectors because the area of the triangle is equal to half of the value. Accordingly, since the vector \vec{n} indicates a direction of the triangles (e.g., TriSoup triangles) representing (e.g., modeling) the portion of the point cloud, the vector \vec{n} may be indicative of the direction normal to a local surface representative of the portion of the point cloud. In some examples, to maximize the effect of the centroid residual while minimizing its coding cost, a one-component residual αᵣₑₛ along the line (C, \vec{n}) 810 may be coded instead of a 3D residual vector.

Cᵣₑₛ=αᵣₑₛ\vec{n}

The residual value αᵣₑₛ may be determined by the encoder as the intersection between the current point cloud and the line (C, \vec{n}), which is along the same direction of the normalized vector \vec{n}. For example, a set of points, of the portion of the point cloud, closest (e.g., within a threshold distance, a threshold number of points) to the line may be determined. The set of points may be projected on the line and the residual value αᵣₑₛ may be determined as the mean component along the line of the projected points. In some examples, the mean may be determined as a weighted mean whose weights depend on the distance of the set of points from the line. For example, a point from the set closer to the line may have a higher weight than another point from the set farther from the line.

In some examples, the residual value αᵣₑₛ may be quantized. For example, it may be quantized by a uniform quantization function having quantization step similar to the quantization precision of the TriSoup vertices Vₖ. By doing so, the quantization error may be maintained to be uniform over all vertices Vₖ and C+Cᵣₑₛ such that the local surface is uniformly approximated.

In some examples, the residual value αᵣₑₛ may be binarized and entropy coded into the bitstream, e.g., by using a unary-based coding scheme. In some examples, the residual value αᵣₑₛ may be coded using a set of flags. For example, a flag f₀ may be coded to indicate if the residual value αᵣₑₛ is equal to zero. If the flag f₀ indicates the residual value αᵣₑₛ is zero, no further syntax elements may be needed. If the flag f₀ indicates the residual value αᵣₑₛ is not zero, a sign bit indicating a sign may be coded and the residual magnitude |αᵣₑₛ|-1 may be coded using an entropy code. For example, the residual magnitude may be coded using a unary coding scheme that codes successive flags fᵢ (i≥1) indicating if the residual value magnitude |αᵣₑₛ| is equal to ‘i’. A binary entropy coder may binarize the residual value αᵣₑₛ into the flags fᵢ (i≥0) and entropy code the binarized residual value as well as the sign bit.

In some examples, compression of the residual value αᵣₑₛ may be improved by determining bounds as shown in FIG. 8C. As shown, the line (C, \vec{n}) 810 intersects the current cuboid 800 (corresponding to a TriSoup node) at two bounding points 820 and 821 and the encoder may impose that the adjusted centroid vertex C+Cᵣₑₛ is located between the two bounding points 820 and 821. These bounding points 820 and 821 also bound the residual value αᵣₑₛ (which may be quantized) as belonging to an integral interval [m, M] where m≤0≤M. By doing so, some bits of the binarized residual value αᵣₑₛ may be inferred. For example, if m=M=0, then residual value αᵣₑₛ is necessarily equal to zero. In another example, if m=0<M, then the sign bit is necessarily positive. More generally, if the residual value αᵣₑₛ is not equal to zero and its sign is known, its magnitude |αᵣₑₛ| may be determined to be bounded by either |m| or M such that the magnitude may be coded by a truncated unary coding scheme that may infer the value of the last of successive flags fᵢ (i≥1).

In some examples, the binary entropy coder used to code the binarized residual value αᵣₑₛ may be a context-adaptive binary arithmetic coder (CABAC) such that the probability model (also referred to as a context or an entropy coder) used to code at least one bit (e.g., fᵢ or sign bit) of the binarized residual value αᵣₑₛ are updated depending on precedingly coded bits. In some examples, the probability model of the binary entropy coder may be determined based on contextual information such as the values of the bounds m and M, the position of vertices Vₖ, or the size of the cuboid. In some examples, the selection of the probability model (i.e., also referred equivalently as an entropy coder or context) may be performed by a dynamic OBUF scheme with the contextual information described above as inputs.

The reconstruction of a decoded point cloud from the set of TriSoup triangles may be referred to as “voxelization” and may be performed, e.g., by ray tracing or rasterization, for each triangle individually before duplicate voxels from the voxelized triangles are removed.

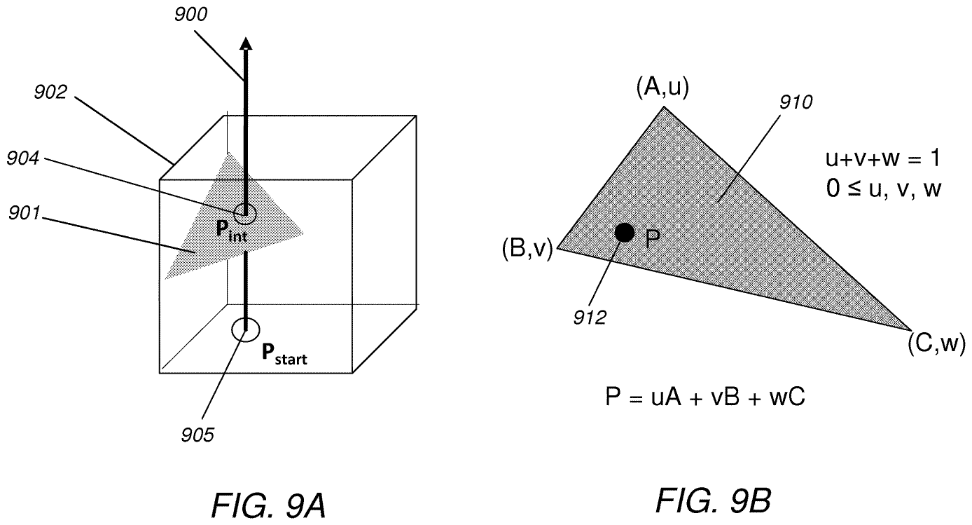

FIG. 9A illustrates an example of voxelization using ray tracing, according to some embodiments. For example, ray-triangle intersection algorithms, such as the Möller-Trumbore algorithm, rely on launching rays to determine whether rays intersect with TriSoup triangles and if so, at what points of the TriSoup triangles. Rays may be launched from integral coordinates that correspond to the centers of voxels. As illustrated by FIG. 9A, rays such as ray 900 may be launched parallel to one of the three coordinate axes of the 3D space, starting from integral coordinates (sometimes referred to as integer coordinates) such as an origin point 905 (shown as origin or starting point Pₛₜₐᵣₜ).

An intersection point 904 (shown as Pint), if any, between ray 900 and a TriSoup triangle 901 belonging to a cube 902, corresponding to a TriSoup node, may be rounded (e.g., quantized) to obtain a decoded point corresponding to a voxel. For example, a ray, launched parallel to a coordinate axis in 3D space, may intersect a TriSoup triangle if and only if the projection, along the ray direction, of the center of a voxel belongs to the TriSoup triangle. In other words, the ray may be determined to intersect the TriSoup triangle if the point of intersection corresponds to the center of the voxel. In some examples, this intersection may be determined by applying a ray-triangle intersection algorithm (e.g., tracing or ray casting technique) such as the Möller-Trumbore algorithm to generate voxels representing the triangle.

Ray tracing techniques such as the Möller-Trumbore algorithm are based on generating, with respect to a triangle, barycentric coordinates of points of intersection between rays and a plane of the triangle. Then, points of the triangle may be determined from the barycentric coordinates.

FIG. 9B illustrates an example of voxelization using barycentric coordinates (u, v, w) of a point 912 (P) relative to a TriSoup triangle 910 having vertices labeled A, B, and C in the 3D space, according to some embodiments. In some examples, point 912 may be determined as an intersection between a ray and a plane of TriSoup triangle 910 (e.g., containing or passing through the three vertices A, B, and C of TriSoup triangle 910). For example, the ray may be launched parallel to one of the three coordinate axes in 3D space. In some examples, this intersection point 912 may be uniquely represented as a sum of the three vertices of TriSoup triangle 910:

P=uA+vB+wC

under the condition u+v+w=1. Therefore, any point P of the plane (containing TriSoup triangle 910) has unique coordinates (u, v, w) in the barycentric coordinate system. A point with barycentric coordinates (u, v, w) includes an ordered triple of numbers u, v, and w. A point with barycentric coordinates (u, v, w) that sum to 1 (i.e., u+v+w=1) is known as homogeneous barycentric coordinates or normalized barycentric coordinates. The barycentric coordinates of the intersection point with respect to TriSoup triangle 910 may be determined using, e.g., the well-known Möller-Trumbore algorithm.

By converting points with Cartesian coordinates in 3D space to homogeneous barycentric coordinates, the three vertices A, B, C of TriSoup triangle 910 have respective barycentric coordinates A(1,0,0), B(0,1,0) and C(0,0,1). In some examples, the convex hull (i.e., TriSoup triangle 910) of the three vertices A, B, and C is equal to the set of all points such that the barycentric coordinates u, v, and w is each greater than or equal to zero:

0≤u, v, w

Therefore, in some examples, the intersection point may be determined to belong to TriSoup triangle 910 based on the intersection point having barycentric coordinates with an ordered triple of values that is each greater than or equal to zero. Relatedly, if at least one of barycentric coordinates (i.e., one of u, v, or w) is negative or less than 0, then the intersection point may be determined to not belong to TriSoup triangle because it will be on the plane, but not on an edge or within the TriSoup triangle. In some examples, a point determined to belong to TriSoup triangle 910 may be the ray intersecting TriSoup triangle 910 (e.g., within or at an edge of TriSoup triangle 910).

In video compression, performance may be improved by using inter-frame prediction. Bitrates needed to compress inter frames are typically one to two orders of magnitude lower than bitrates of intra frames that, by definition, do not use inter-frame prediction. Point cloud data may behave differently because the 3D geometry is coded, unlike video coding where typically only the attributes (e.g., colors) are coded after projection of the 3D geometry onto a 2D plane (e.g., a camera sensor). Even if 2D-projected attributes are expected to temporally have a higher correlation than their underlying 3D geometry, it is nevertheless expected that inter-frame prediction between 3D point clouds may provide improved compression capability than intra frame prediction alone within a point cloud. The octree may benefit from inter-frame prediction and geometry compression gains.

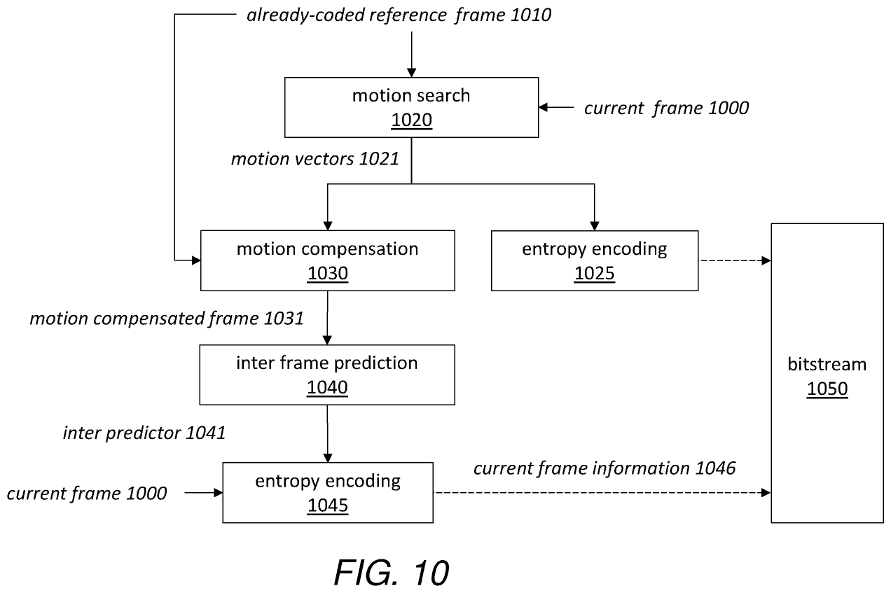

The general framework of inter frame prediction for 3D point clouds is similar to the one of video compression, as depicted in FIG. 10 for the encoding process. A current frame (image or point cloud frame 1000) is coded relative to an already-coded reference frame 1010 (image or point cloud frame). A motion search 1020 is performed from the already-coded reference frame 1010 toward the current frame 1000 such as to obtain motion vectors 1021 that represent a motion flow between the two frames 1010 and 1000. In video compression, motion vectors are 2-component (or 2D) vectors representing the motion from reference blocks of pixels to current blocks of pixels. In point cloud compression, motion vectors are 3-component (or 3D) vectors representing the motion from reference sets of 3D points to current sets of 3D points. Motion vectors 1021 are entropy encoded 1025 into a bitstream 1050. The reference frame 1010 is motion compensated 1030 to obtain a motion compensated frame 1031. Motion compensation involves moving the pixels (respectively points) of the reference image (respectively point cloud frame) according to the 2D (respectively 3D) motion vectors. The obtained motion compensated frame is “closer” to the current frame than the reference frame in the sense that the color difference (respectively point distance) between the motion compensated frame 1031 and the current frame 1000 is, on average, smaller than between the reference frame 1010 and the current frame 1000. In a next step, inter-frame prediction 1040 is performed to obtain inter predictor 1041 based on the motion compensated frame 1031. Inter predictor 1041 is then used to drive the entropy encoding (1045) of current frame information 1046 into the bitstream 1050 based on inter-frame predictive information.

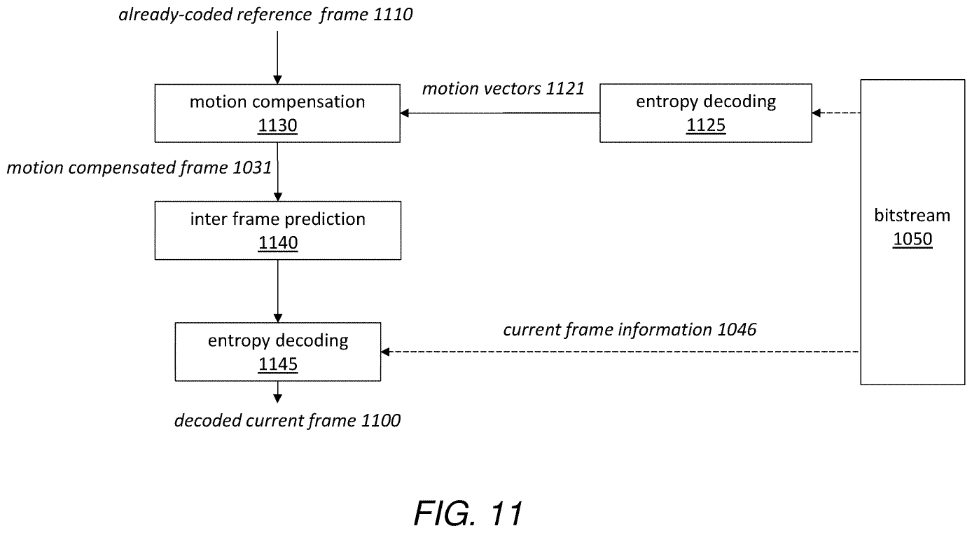

The general framework of inter-frame prediction for 3D point clouds is similar to the one of video compression, as depicted in FIG. 11 for the decoding process. FIG. 11 illustrates a decoding process that decodes a bitstream 1050 encoded by the encoding process of FIG. 10 to obtain a decoded current frame 1100. Motion vectors 1121 are entropy decoded (1125) from the bitstream 1050. An already-coded reference frame 1110 is motion compensated (1130) using the decoded motion vectors 1121 to obtain a motion compensated frame 1131. Then, inter-frame prediction (1140) is performed to obtain inter predictor 1041 based on the motion compensated frame 1031. Inter predictor 1041 is then used to drive the entropy decoding (1145) of current frame information 1046 from the bitstream 1050. Finally, the decoded current frame 1100 is obtained based on the decoded current frame information.

In video coding, inter residuals are constructed as the difference of colors, pixel per pixel, between a current block of pixels belonging to the current frame (here image) and a co-located compensated block of pixels belonging to the motion compensated frame (here image). Inter residuals are then arrays of color differences that have typically small magnitude and thus may be efficiently compressed. Inter residuals based on the current frame 1000 and the motion compensated frame 1031 may be entropy coded (encoded/decoded). Inter residuals may carry more compressible information than the current frame itself or the current frame that has undergone an intra prediction process. Therefore, the entropy coding (1045, 1145) may be more efficient such as to obtain a bitstream 1050 with reduced size compared to a bitstream obtained by coding the current frame 1000 that has not benefited from inter-frame prediction.

In point cloud compression, there is no such concept as the “difference” between two sets of points and the concept of inter residual cannot be straightforwardly generalized to point clouds. For prediction of an occupancy tree, e.g., occupancy octree, representing a point cloud geometry, the concept of inter residual may be replaced by conditional entropy coding where conditional information for performing conditional entropy coding is constructed based on a motion compensated point cloud frame. This may be extended to the framework of dynamic OBUF.

When coding the geometry of a point cloud using an occupancy tree (e.g., an occupancy octree), the inter predictor takes the form of inter-frame prediction information used as input to the dynamic OBUF process that selects an entropy coder to code an occupancy bit associated with a current node of the occupancy tree.

The motion field between trees (e.g., occupancy octrees) may be made of 3D motion vectors associated with 3D prediction units (PU) that have volumes that may include at least a part of one or several volumes (cuboids) associated with nodes of the occupancy tree. The motion compensation may be performed volume per volume based on the 3D motion vectors to obtain a motion compensated point cloud frame in one or more current volumes. The inter-frame prediction information of a current volume associated with a current node of the occupancy tree may be obtained based on the presence of at least one point of the motion compensated point cloud frame in the current volume.

As described hereinabove in relation with FIG. 6, a current occupancy bit of an octree may be coded by an entropy coder selected by the output of a dynamic OBUF LUT of coder indices that takes a neighborhood configuration β as input. The neighborhood configuration β may be constructed using intra-frame prediction information based on already-coded occupancy bits associated with neighboring volumes relative to the current volume associated with the current node whose occupancy is signaled by the current occupancy bit.

The construction of the neighborhood configuration β may be extended using inter-frame prediction information. An inter predictor occupancy bit may be defined for a current occupancy bit as a bit representative of the presence of at least one point of a motion compensated point cloud within the current volume. In the case that motion compensation is efficient, a strong correlation between the current occupancy bit and the inter predictor occupancy bit may exist because the current and motion compensated point cloud frames should be close to each other. Practically, using the inter predictor occupancy bit as a bit of the neighborhood configuration β may lead to better compression performance of the octree (e.g., dividing the size of the octree bitstream by a factor two).

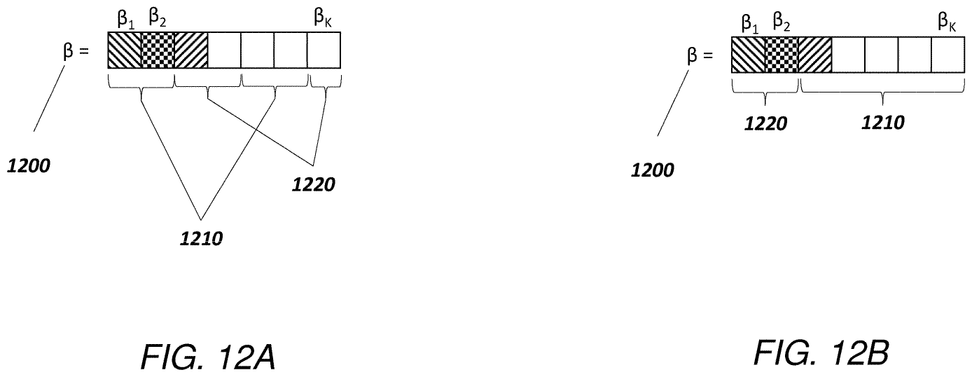

FIG. 12A-B illustrates examples of construction of a contextual information β (1200), used as input to dynamic OBUF, based on intra-frame prediction information and inter-frame prediction information, according to some embodiments. The contextual information β (1200) is generated as a series of bits βₖ (k=1, . . . , K). Some of the bits include intra bits 1210 generated based on intra-frame information, for example, based on the occupancy information of neighboring already-coded nodes. Some of the bits include inter bits 1220 generated based on inter-frame prediction information, for example, the points of a motion compensated point cloud frame. Intra bits 1210 and inter bits 1220 may be mixed (interleaved) as in FIG. 12A. Alternatively, it has been observed that inter-frame information is usually a stronger information (e.g., has higher correlation or accuracy for predicting current frame information) than intra-frame information. Accordingly, in some embodiments as shown in FIG. 12B, the inter bits 1220 may be generated and placed or set as leading bits of the contextual information β (1200).

In G-PCC, two bits β₁ and β₂ are put as leading inter bits 1220, as in FIG. 12B. These two bits represent a 3-state inter-frame information constructed based on the points of the motion compensated point cloud frame that belong to the volume associated with the current node whose occupancy bit is coded by the entropy coder selected by dynamic OBUF taking the contextual information β (1200) as input.

The three states of the 3-state inter-frame prediction information may be defined by:
state S0: there is no point of the motion compensated point cloud frame in the volume associated with the current node,
state S1: there are 1 or 2 points of the motion compensated point cloud frame in the volume associated with the current node, and
state S 2: there are at least 3 points of the motion compensated point cloud frame in the volume associated with the current node.
   State S0 predicts the current node to be unoccupied, state S1 weakly predicts the current node to be occupied, and state S2 strongly predicts the current node to be occupied. The value of the state is represented by the two bits β₁β₂. For example, β₁β₂ may be equal to 00 for state S 0, β₁β₂ may be equal to 10 for state S1, and β₁β₂ may be equal to 11 for state S2.

In existing technologies, the inter-frame prediction information (e.g., the points of the motion compensated point cloud) is aggressively reduced to and represented by a 3-state information. On one hand it is necessary to reduce the inter-frame prediction information to less information that can be inserted into the contextual information β. On the other hand, this reduction should ideally keep most of the information predictive capability of the occupancy bit of the current node. The design of the reduction of inter-frame prediction information is an important step of the inter-frame prediction scheme. By improving on current implementations of inter-frame prediction information reduction, that use two fixed thresholds (0 and 2) on the number of points of the motion compensated point cloud, higher compression performance related to higher prediction accuracy can be obtained.

Embodiments of the present disclosure relate to constructing (e.g., generating) states of inter-frame prediction information based not only on the motion compensated point cloud frame, but also based on the size of a current volume associated with a current node of an occupancy tree representing space-partitioning of a volume encompassing a point cloud frame.

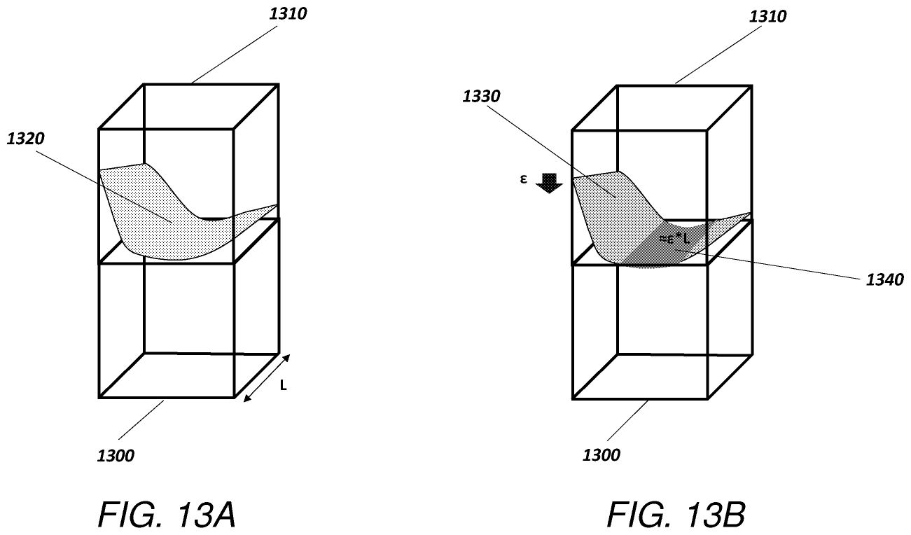

In some embodiments, the inter-frame prediction information is based on the number of points of the motion compensated point cloud frame that belong to the current volume. Existing implementations of generating inter-frame prediction information may lead to inaccurate prediction. FIG. 13A and FIG. 13B illustrate an example of this motion estimation error of a motion compensated point cloud geometry, according to some embodiments. The number of points of the motion compensated point cloud frame, that may be wrongly located in a current volume, is typically proportional to the size of the current node as illustrated by FIG. 13A where a (cubic) current node 1300 (e.g., shown as a sub-volume such as a cuboid) is depicted together with a neighboring node 1310 of same size. In FIG. 13A, the current point cloud geometry to be coded is represented by a surface 1320 such that the current node 1300 is not occupied, and the neighboring node 1310 is occupied. The length of the node edges is L. In FIG. 13B, the motion compensated point cloud geometry is represented by another surface 1330 that does not exactly match the surface 1320 of the point cloud geometry to be coded due to some motion estimation error.

Assuming the motion estimation error is of magnitude ε, the area of the portion 1340 of the surface 1330, representing motion compensated point cloud geometry, that wrongly intersects the non-occupied current node 1300 is about ε*L. According to some embodiments, states of inter-frame prediction information may be generated (or constructed) based on the size (e.g., here the length L) of the current node to reduce the effects of motion estimation error; for example, having no more than ε*L points of the motion compensated point cloud geometry in the current node may be a better predictor of the current node to be non-occupied than using a fixed threshold (e.g., than having at least one point of the motion compensated point cloud in the current node). Thus, the fixed threshold 0 used in existing implementations on the number of points may be replaced by a threshold proportional to the length L according to embodiments of the present disclosure.

It should be understood that reference to current and neighboring nodes in FIGS. 13A-B may refer to the respective current sub-volume (e.g., cuboid) and neighboring sub-volume (e.g., another cuboid) of a volume containing the point cloud.

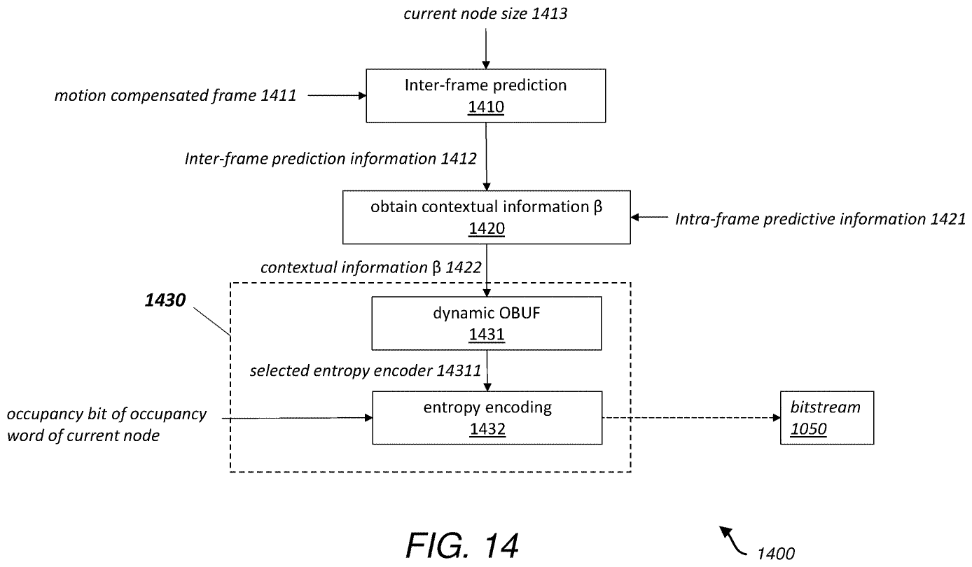

FIG. 14 illustrates an example encoding process 1400 for encoding an occupancy bit of an occupancy word of a current node of an occupancy tree based on inter-frame prediction information, according to embodiments. For example, process 1400 may be performed by an encoder (e.g., encoder 114 of FIG. 1). In some examples, blocks 1410-1432 may represent components within the encoder.

The occupancy tree, e.g., occupancy octree, represents a space-partitioning (or spatial partitioning) of a volume encompassing a current point cloud frame as discussed above in relation with FIG. 3.

At block 1410, inter-frame prediction is performed to obtain inter-frame prediction information 1412 based on a motion compensated point cloud frame 1411 and the size 1413, for example represented or approximated by the length L, of current volume associated with a current node of the occupancy tree.

At block 1420, a contextual information β (1422) is obtained (e.g., constructed) based on the inter-frame prediction information 1412.

In some embodiments, the contextual information β (1422) may be obtained (e.g., constructed) based on the inter-frame prediction information 1412 and intra-frame prediction information 1421.

At block 1430, an occupancy bit of the occupancy word of the current node is entropy encoded based on the contextual information β (1422) into the bitstream 1050.

In some embodiments, block 1430 may comprise block 1431 and block 1432.

At block 1431, an entropy encoder 14311 is selected based on the contextual information β (1422).

In some embodiments, an OBUF or dynamic OBUF process takes contextual information β (1422) as input and selects the entropy encoder 14311, as explained above with respect to FIGS. 5-6.

At block 1432, the occupancy bit of the occupancy word of the current node is entropy encoded, by the selected entropy encoder 14311, into the bitstream 1050.

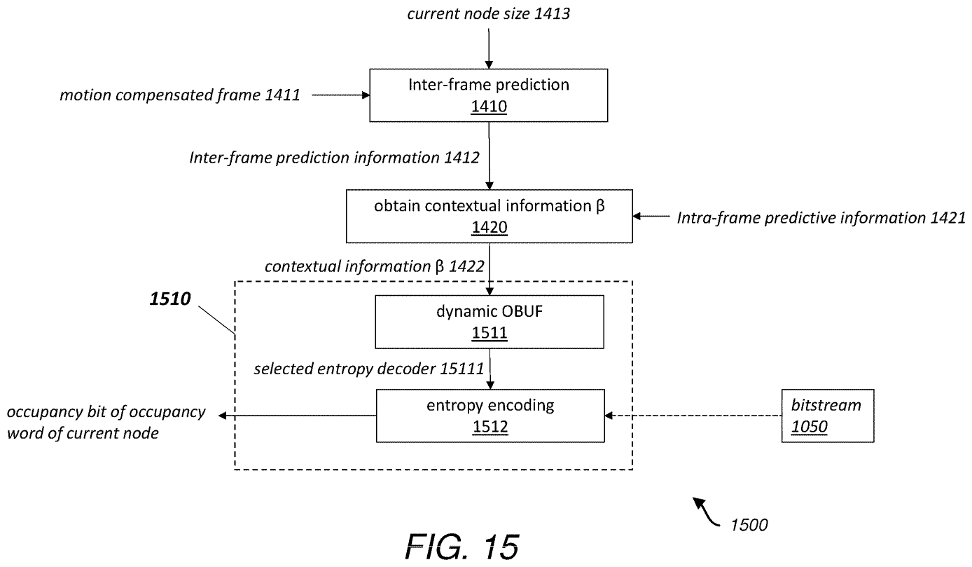

FIG. 15 illustrates an example decoding process 1500 for decoding an occupancy bit of an occupancy word of a current node of an occupancy tree based on inter-frame prediction information, according to embodiments. For example, process 1500 may be performed by a decoder (e.g., decoder 120 of FIG. 1). In some examples, blocks 1510-1512 may represent components within the decoder. The process 1500 may include many of the same operations (shown as having the same labeled blocks) as those described in FIG. 14. Different from the process 1400 of FIG. 14, the process 1500 includes block 1510 (1511 and 1512).

At block 1510, an occupancy bit of an occupancy word of the current node of an occupancy tree representing space-partitioning (or spatial partitioning) of a volume encompassing the current point cloud frame, as discussed above in relation with FIG. 3, is entropy decoded, from the bitstream 1050, based on the contextual information β (1422).

In some embodiments, block 1510 may comprise block 1511 and block 1512.

At block 1511, an entropy decoder is selected based on the contextual information β (1422).

In some embodiments, an OBUF or dynamic OBUF process takes contextual information β (1422) as input and selects the entropy decoder 15111, as explained above with respect to FIGS. 5-6.

At block 1512, the occupancy bit of the occupancy word of the current node is entropy decoded, by the selected entropy decoder 15111, from the bitstream 1050.

In some embodiments, the current node may be a cubic node and the size 1413 of the current volume is the length of an edge of the current volume.

In some embodiments, the current volume may be a cuboid and the size 1413 of the current volume is a mean length of the edges of the current volume.

In some embodiments, the size 1413 of the current volume may be the volume of the current volume.

In some embodiments, the size 1413 of the current volume may be a length obtained to represent the cubic root of the current volume. For example, the obtained length may be an estimate of the cubic root. For example, the length may be a length of the current volume, such as a cuboid corresponding to the current node.

In some embodiments, the inter-frame prediction information 1412 may be obtained based on the presence of at least one point of the motion compensated point cloud frame in the current volume and based on the size of the current volume.

In some embodiments, the inter-frame prediction information 1412 may be a set of bits representing inter states obtained by reducing the presence of at least one point of the motion compensated point cloud frame in the current volume and based on the size of the current volume. The set of bits may represent a label/index associated with each inter state.

For example, the set of bits representing the inter states may be made of two bits representing 4 inter states.

In some embodiments, the set of bits representing the inter states may be obtained by juxtaposing first bits representing the size of the current volume and second bits representing information related to the motion compensated point cloud frame.

For example, the first bits may be codewords representing the closest integer of the log2 of the size of the current volume.

For example, the second bits may be codewords representing quantized values of the number of points of the motion compensated point cloud frame belonging to the current volume.

In some embodiments, the number of points of the motion compensated point cloud frame belonging to the current volume may be quantized by using a quantizer that depends on the size of the current volume. The set of bits is thus a codeword representing the quantized number of points.

In some embodiments, the quantizer may be defined by quantization intervals whose at least one bound depends on the size of the current volume.

In some embodiments, the at least one bound Bi of a quantization interval may equal to a product of a constant value by the size L of the current volume.

In some embodiments, the at least one bound Bi of a quantization interval may equal to a maximum between a floor value for the bound Bi and the product of a constant value by the size L of the current volume. Using a floor value ‘b’ may be advantageous because it avoids all the bounds shrinking to zero when the size of current volume is small and thus to avoid overlapping inter states.

In some embodiments, a single constant value is used to derive the at least one bound Bi.

In some embodiments, different constant values are used to derive the at least one bound Bi.

In some embodiments, the at least one constant value may be signaled in a bitstream.

In some embodiments, the at least one constant value may be representative of an error of an estimation of at least one motion vector used for obtaining the motion compensated point cloud frame 1411.

For example, the quantizer may be defined by four quantization intervals.

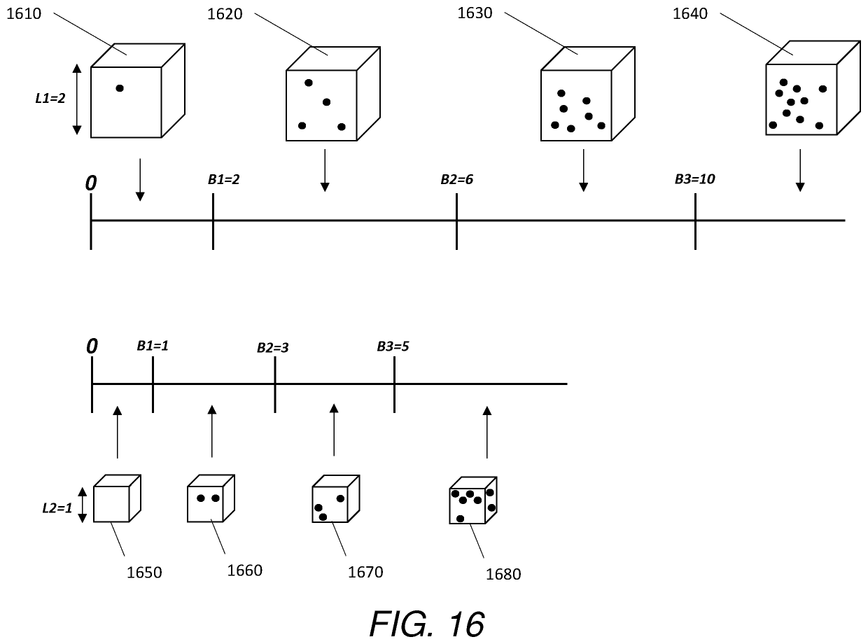

FIG. 16 illustrates an example of inter states based on quantized numbers of points of a motion compensated point cloud frame, according to some embodiments. As shown, quantizers may depend on the size of the current volume containing a portion of the point cloud to be coded.

In this example, the set of bits representing the inter states is made of two bits representing 4 inter states. The 4 inter states are obtained by quantizing the number of points of the motion compensated point cloud frame belonging to the current volume associated with the current node. Quantizing may be obtained by using three bounds Bᵢ=cᵢ*L (i=1, 2 or 3) where L is the size of the current node and cᵢ are three fixed constant values. The 4 inter states are defined by the number of points of the motion compensated point cloud frame belonging to the current volume being in one of the 4 intervals [0, B₁], [B₁, B₂], [B₂, B₃] and [B₃, ∞]. Constant ci may have fixed values such as c₁=1, c₂=3 and c₃=5, though other fixed values may be possible.

On top of FIG. 16, a current volume, e.g., cuboid, has an example size L1 equal to 2. The associated bounds for this example current volume are thus B1=c₁*L1=1*2=2, B2=c₂*L1=3*2=6 and B3=c₃*L1=5*2=10. On bottom of FIG. 16, another current volume, e.g., cuboid, has an example size L2 equal to 1. The associated bounds for this other current volume are thus B1=c₁*L2=1*1=1, B2=c₂*L2=3*1=3 and the bound B3=c₃*L2=5*1=5.

The example values of FIG. 16 lead to different bounds Bi to illustrate the effect of the size of the current volume on the quantizer. Any other values may be used to define the quantizer.

On top of FIG. 16, four examples of current volumes are shown. A current volume 1610 comprises one point of the motion compensated point cloud frame 1411. The number of points equals 1 and belongs to the interval [0,B₁]=[0, 2] and an index 0 may be assigned to the current volume 1610. A current volume 1620 comprises 4 points of the motion compensated point cloud frame 1411. The number of points equals 4 and belongs to the interval [B₁, B₂]=[2, 6] and an index 1 may be assigned to the current volume 1620. A current volume 1630 comprises 7 points of the motion compensated point cloud frame 1411. The number of points equals 7 and belongs to the interval [B₂, B₃]=[6, 10] and an index 2 may be assigned to the current volume 1630. A current volume 1640 comprises 10 points of the motion compensated point cloud frame 1411. The number of points equals 10 and belongs to the interval [B₃, ∞]=[10, ∞] and an index 3 may be assigned to the current volume 1640.

On bottom of FIG. 16, four examples of current volumes are shown. A current volume 1650 does not comprise any point of the motion compensated point cloud frame 1411. The number of points equals 0 and belongs to the interval [0, B₁]=[0,1] and an index 0 may be assigned to the current volume 1650. A current volume 1660 comprises 2 points of the motion compensated point cloud frame 1411. The number of points equals 2 and belongs to the interval [B₁, B₂]=[1, 3] and an index 1 may be assigned to the current volume 1660. A current volume 1670 comprises 3 points of the motion compensated point cloud frame 1411. The number of points equals 3 and belongs to the interval [B₂, B₃]=[3, 5] and an index 2 may be assigned to the current volume 1670. A current volume 1680 comprises 7 points of the motion compensated point cloud frame 1411. The number of points equals 7 and belongs to the interval [B₃, ∞]=[5, ∞] and an index 3 may be assigned to the current volume 1680.

For example, two bits may represent the index associated with each of the 4 intervals.

In some embodiments, contextual information β (1422) may be obtained further based on bits representing intra states based on intra-frame prediction information 1421.

In some embodiments, the contextual information β (1422) may be obtained by interleaving the set of bits representing inter states with the bits representing intra states (e.g., as shown in FIG. 12B).

In some embodiments, the contextual information β (1422) may be obtained by juxtaposing the set of bits representing inter states to the bits representing intra states.

In some embodiments, the set of bits representing the inter states may be the leading bits of the contextual information β (1422) (e.g., as shown in FIG. 12A).

In some embodiments, the intra-frame prediction information 1421 may be based on the occupancy information of at least one neighboring already-coded node of the current node.

In some embodiments, the motion compensated point cloud frame may be based on a motion field between the occupancy tree of the point cloud frame and an occupancy tree of a reference point cloud frame.

In some embodiments, the motion field may be made of 3D motion vectors associated with 3D prediction units that have volumes that include at least a part of one or several volumes associated with nodes of the occupancy tree of the point cloud frame.

In some embodiments, the motion compensated point cloud frame 1411 may be obtained by performing motion compensation of the reference point cloud frame based on the 3D motion vectors.

In some embodiments, the motion compensation is performed volume per volume associated with node of the occupancy tree of the point cloud frame.

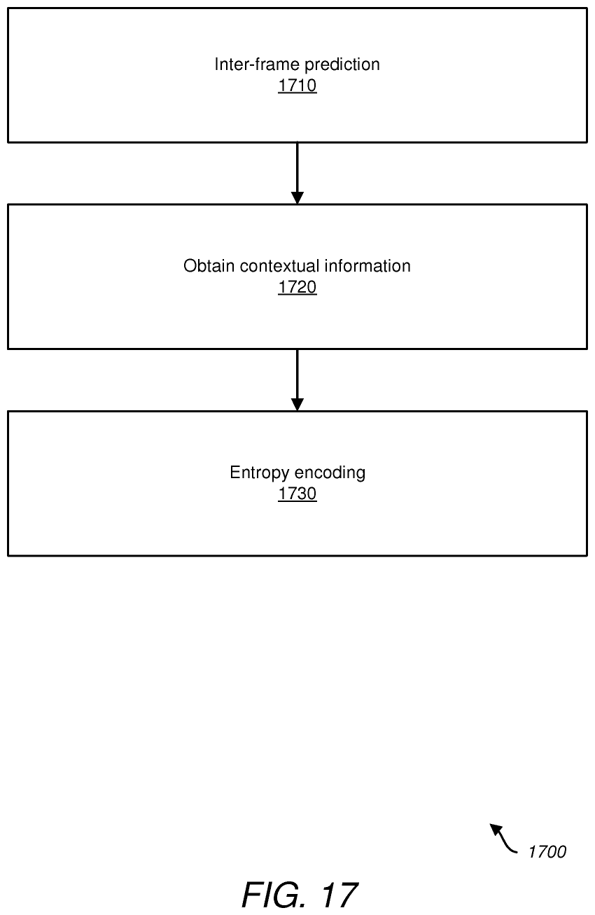

FIG. 17 illustrates a flowchart of an example method for encoding, in a bitstream, occupancy bits of occupancy words of nodes of an occupancy tree representing a space partitioning of a volume encompassing a current point cloud frame, according to some embodiments. For example, method 1700 may be performed by an encoder (e.g., encoder 114 of FIG. 1).

The occupancy tree, e.g., occupancy octree, may be obtained that represents space-partitioning (or spatial partitioning) of the volume encompassing the current point cloud frame, as discussed above in relation with FIG. 3.

At block 1710, inter-frame prediction is performed to obtain inter-frame prediction information based on a motion compensated point cloud frame and the size of current volume associated with each current node of the occupancy tree. Examples of inter-frame prediction information are described above with respect to FIG. 16.

For example, based on a motion compensated frame and the size of a current volume associated with a current node of the occupancy tree, inter-frame prediction information may be obtained (e.g., generated) for the current node.

At block 1720, contextual information is obtained based on the inter-frame prediction information. Examples of generating the contextual information based on inter-frame prediction information are described above with respect to FIGS. 12A-B.

At block 1730, each occupancy bit of occupancy word of the current node is entropy encoded, into the bitstream, based on the contextual information.

For example, an occupancy bit of an occupancy word of the current node may be entropy encoded, into the bitstream, based on the contextual information generated for coding the occupancy bit and/or occupancy word.

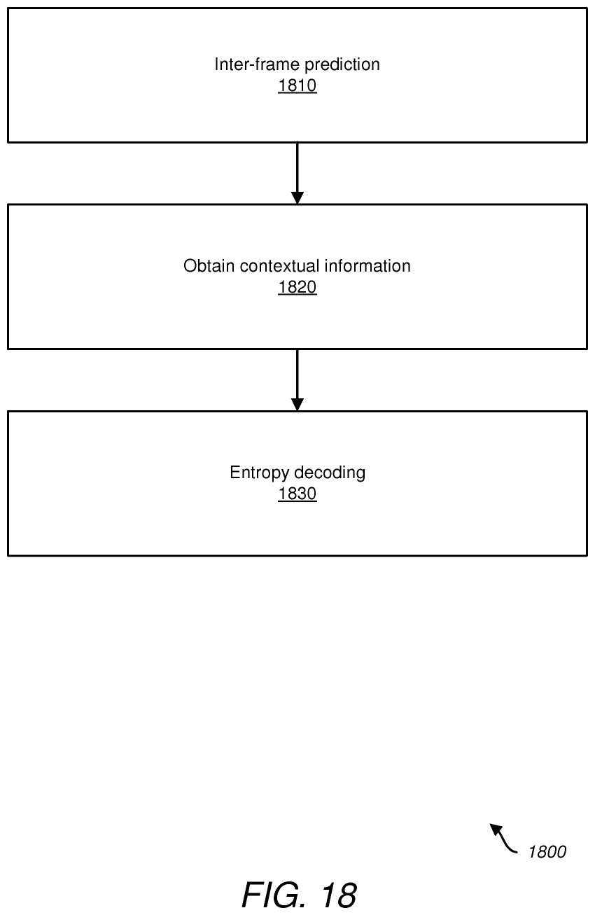

FIG. 18 illustrates a flowchart of an example method for decoding, from a bitstream, occupancy bits of occupancy words of nodes of an occupancy tree representing a space partitioning (e.g., spatial partitioning) of a volume encompassing a point cloud frame, according to some embodiments. For example, process 1800 may be performed by a decoder (e.g., decoder 120 of FIG. 1).

At block 1810, inter-frame prediction is performed to obtain inter-frame prediction information based on a motion compensated point cloud frame and the size of current volume associated with each current node of an occupancy tree representing space-partitioning of a volume encompassing the current point cloud frame as discussed above in relation with FIG. 3. Examples of inter-frame prediction information are described above with respect to FIG. 16.

For example, based on a motion compensated frame and the size of a current volume associated with a current node of the occupancy tree, inter-frame prediction information may be obtained (e.g., generated) for the current node.

At block 1820, a contextual information is obtained based on the inter-frame prediction information. Examples of generating the contextual information based on inter-frame prediction information are described above with respect to FIGS. 12A-B.

At block 1830, each occupancy bit of the occupancy word of the current node is entropy decoded, from the bitstream, based on the contextual information.

For example, an occupancy bit of an occupancy word of the current node may be entropy decoded, from the bitstream, based on the contextual information generated for coding the occupancy bit and/or occupancy word.

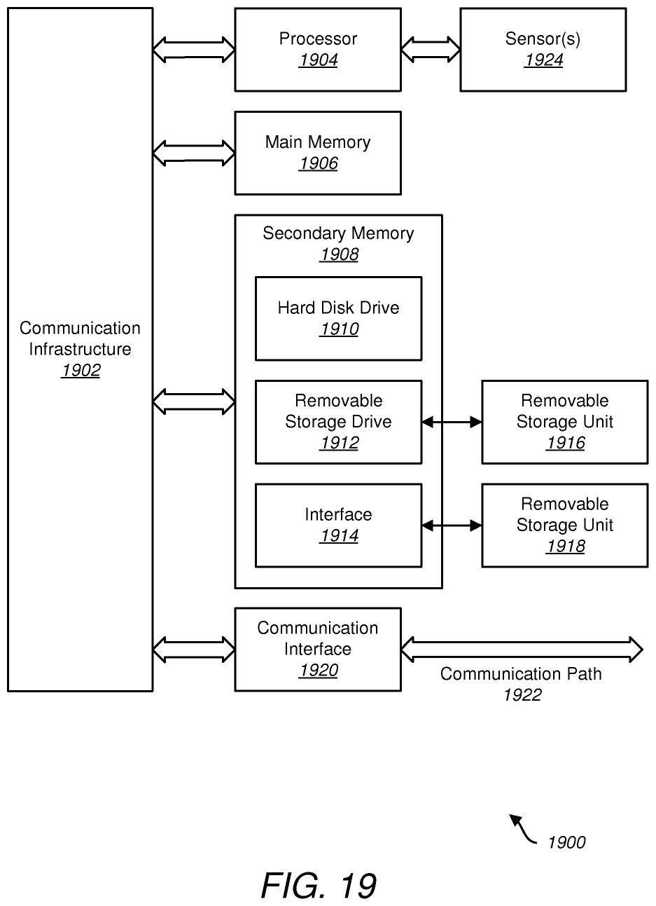

Embodiments of the present disclosure may be implemented in hardware using analog and/or digital circuits, in software, through the execution of instructions by one or more general purpose or special-purpose processors, or as a combination of hardware and software. Consequently, embodiments of the disclosure may be implemented in the environment of a computer system or other processing system. An example of such a computer system 1900 is shown in FIG. 19. Blocks depicted in the figures above, such as the blocks in FIGS. 1, 6, 14, and 15 may execute on one or more computer systems 1900. Furthermore, each of the steps of the flowcharts depicted in the present disclosure may be implemented on one or more computer systems 1900. When more than one computer system 1900 is used to implement embodiments of the present disclosure, the computer systems 1900 may be interconnected by one or more networks to form a cluster of computer systems that may act as a single pool of seamless resources. The interconnected computer systems 1900 may form a “cloud” of computers.

Computer system 1900 includes one or more processors, such as processor 1904. Processor 1904 may be, for example, a special purpose processor, general purpose processor, microprocessor, or digital signal processor. Processor 1904 may be connected to a communication infrastructure 1902 (for example, a bus or network). Computer system 1900 may also include a main memory 1906, such as random access memory (RAM), and may also include a secondary memory 1908.

Secondary memory 1908 may include, for example, a hard disk drive 1910 and/or a removable storage drive 1912, representing a magnetic tape drive, an optical disk drive, or the like. Removable storage drive 1912 may read from and/or write to a removable storage unit 1916 in a well-known manner. Removable storage unit 1916 represents a magnetic tape, optical disk, or the like, which is read by and written to by removable storage drive 1912. As will be appreciated by persons skilled in the relevant art(s), removable storage unit 1916 includes a computer usable storage medium having stored therein computer software and/or data.

In alternative implementations, secondary memory 1908 may include other similar means for allowing computer programs or other instructions to be loaded into computer system 1900. Such means may include, for example, a removable storage unit 1918 and an interface 1914. Examples of such means may include a program cartridge and cartridge interface (such as that found in video game devices), a removable memory chip (such as an EPROM or PROM) and associated socket, a thumb drive and USB port, and other removable storage units 1918 and interfaces 1914 which allow software and data to be transferred from removable storage unit 1918 to computer system 1900.

Computer system 1900 may also include a communications interface 1920. Communications interface 1920 allows software and data to be transferred between computer system 1900 and external devices. Examples of communications interface 1920 may include a modem, a network interface (such as an Ethernet card), a communications port, etc. Software and data transferred via communications interface 1920 are in the form of signals which may be electronic, electromagnetic, optical, or other signals capable of being received by communications interface 1920. These signals are provided to communications interface 1920 via a communications path 1922. Communications path 1922 carries signals and may be implemented using wire or cable, fiber optics, a phone line, a cellular phone link, an RF link, and other communications channels.

Computer system 1900 may also include one or more sensor(s) 1924. Sensor(s) 1924 may measure or detect one or more physical quantities and convert the measured or detected physical quantities into an electrical signal in digital and/or analog form. For example, sensor(s) 1924 may include an eye tracking sensor to track the eye movement of a user. Based on the eye movement of a user, a display of a point cloud may be updated. In another example, sensor(s) 1924 may include a head tracking sensor to track the head movement of a user. Based on the head movement of a user, a display of a point cloud may be updated. In yet another example, sensor(s) 1924 may include a camera sensor for taking photographs and/or a 3D scanning device, like a laser scanning, structured light scanning, and/or modulated light scanning device. 3D scanning devices may determine geometry information by moving one or more laser heads, structured light, and/or modulated light cameras relative to the object or scene being scanned. The geometry information may be used to construct a point cloud.

As used herein, the terms “computer program medium” and “computer readable medium” are used to refer to tangible storage media, such as removable storage units 1916 and 1918 or a hard disk installed in hard disk drive 1910. These computer program products are means for providing software to computer system 1900. Computer programs (also called computer control logic) may be stored in main memory 1906 and/or secondary memory 1908. Computer programs may also be received via communications interface 1920. Such computer programs, when executed, enable computer system 1900 to implement the present disclosure as discussed herein. In particular, the computer programs, when executed, enable processor 1904 to implement the processes of the present disclosure, such as any of the methods described herein. Accordingly, such computer programs represent controllers of the computer system 1900.

In another embodiment, features of the disclosure may be implemented in hardware using, for example, hardware components such as application-specific integrated circuits (ASICs) and gate arrays. Implementation of a hardware state machine to perform the functions described herein will also be apparent to persons skilled in the relevant art(s).

What is claimed is:

1. A method comprising:
obtaining a size of a current volume associated with a current node of an occupancy tree representing a spatial partitioning of a volume encompassing a point cloud frame;
determining an index representing an inter state, of a plurality of inter states, based on comparing a number of points of a motion-compensated point cloud frame belonging in the current volume with at least a threshold dependent on the size of the current volume;
selecting an entropy coder based on the index; and
entropy decoding, from a bitstream and based on the selected entropy coder, an occupancy bit of an occupancy word of the current node.

2. The method of claim 1, wherein the current volume is a cuboid and the size of the current volume is represented by the length of an edge of the cuboid.

3. The method of claim 2, wherein the plurality of inter states correspond to respective quantization intervals each having at least one bound that is based on the size of the current volume, and wherein the index corresponds to a quantization interval in which the number of points of the motion-compensated point cloud frame belonging to the current volume is in.

4. The method of claim 3, wherein the at least a threshold corresponds to the at least one bound.

5. The method of claim 2, wherein the motion-compensated point cloud frame is obtained based on a motion field between the occupancy tree of the point cloud frame and an occupancy tree of a reference point cloud frame.

6. The method of claim 5, wherein the motion field comprises 3D motion vectors associated with 3D prediction units that have volumes that include at least a part of one or several volumes associated with nodes of the occupancy tree of the point cloud frame.

7. The method of claim 5, wherein the motion-compensated point cloud frame is obtained by performing motion compensation of a reference point cloud frame based on 3D motion vectors of the motion field.

8. A decoder comprising:
one or more processors; and
memory storing instructions that, when executed by the one or more processors, cause the decoder to:
obtain a size of a current volume associated with a current node of an occupancy tree representing a spatial partitioning of a volume encompassing a point cloud frame;
determine an index representing an inter state, of a plurality of inter states, based on comparing a number of points of a motion-compensated point cloud frame belonging in the current volume with at least a threshold dependent on the size of the current volume;
select an entropy coder based on the index; and
entropy decode, from a bitstream and based on the selected entropy coder, an occupancy bit of an occupancy word of the current node.

9. The decoder of claim 8, wherein the current volume is a cuboid and the size of the current volume is represented by the length of an edge of the cuboid.

10. The decoder of claim 9, wherein the plurality of inter states correspond to respective quantization intervals each having at least one bound that is based on the size of the current volume, and wherein the index corresponds to a quantization interval in which the number of points of the motion-compensated point cloud frame belonging to the current volume is in.

11. The decoder of claim 10, wherein the at least a threshold corresponds to the at least one bound.

12. The decoder of claim 9, wherein the motion-compensated point cloud frame is obtained based on a motion field between the occupancy tree of the point cloud frame and an occupancy tree of a reference point cloud frame.

13. The decoder of claim 12, wherein the motion field comprises 3D motion vectors associated with 3D prediction units that have volumes that include at least a part of one or several volumes associated with nodes of the occupancy tree of the point cloud frame.

14. The decoder of claim 12, wherein the motion-compensated point cloud frame is obtained by performing motion compensation of a reference point cloud frame based on 3D motion vectors of the motion field.

15. A non-transitory computer-readable medium comprising instructions that, when executed by one or more processors of a decoder, cause the decoder to:
obtain a size of a current volume associated with a current node of an occupancy tree representing a spatial partitioning of a volume encompassing a point cloud frame;
determine an index representing an inter state, of a plurality of inter states, based on comparing a number of points of a motion-compensated point cloud frame belonging in the current volume with at least a threshold dependent on the size of the current volume;
select an entropy coder based on the index; and
entropy decode, from a bitstream and based on the selected entropy coder, an occupancy bit of an occupancy word of the current node.

16. The non-transitory computer-readable medium of claim 15, wherein the current volume is a cuboid and the size of the current volume is represented by the length of an edge of the cuboid.

17. The non-transitory computer-readable medium of claim 16, wherein the plurality of inter states correspond to respective quantization intervals each having at least one bound that is based on the size of the current volume, and wherein the index corresponds to a quantization interval in which the number of points of the motion-compensated point cloud frame belonging to the current volume is in.

18. The non-transitory computer-readable medium of claim 17, wherein the at least a threshold corresponds to the at least one bound.

19. The non-transitory computer-readable medium of claim 16, wherein the motion-compensated point cloud frame is obtained based on a motion field between the occupancy tree of the point cloud frame and an occupancy tree of a reference point cloud frame.

20. The non-transitory computer-readable medium of claim 19, wherein the motion field comprises 3D motion vectors associated with 3D prediction units that have volumes that include at least a part of one or several volumes associated with nodes of the occupancy tree of the point cloud frame.
